(19) United States
(12) Patent Application Publication
(10) Pub. No.: US 2011/0206596 A1
(43) Pub. Date: Aug. 25, 2011

(54) INORGANIC MULTILAYERED NANOSTRUCTURES

(75) Inventors: Reshef Tenne, Rehovot (IL); Sung You Hong, Seoul (KR); Ronen Kreizman, Rishon LeZion (IL); Francis Leonard Deepak, Chennai (IN)

(73) Assignee: YEDA RESEARCH AND DEVELOPMENT COMPANY LTD., Rehovot (IL)

(21) Appl. No.: 13/126,471

(22) PCT Filed: Nov. 10, 2009
(86) PCT No.: PCT/IL09/01054

§ 371 Date: Apr. 28, 2011

Related U.S. Application Data
(60) Provisional application No. 61/112,795, filed on Nov. 10, 2008.

(51) Int. Cl. C01G 41/00; C01G 21/16; C01G 29/00; C01G 30/00; C01G 39/06; B82Y 30/00

(52) U.S. Cl. 423/463; 423/511; 977/734

(57) ABSTRACT

Provided is a multilayered nanostructure including at least one first layered nanotube including at least one first inorganic material and having an inner void holding at least one second layered nanotube including at least one second inorganic material; where the at least on first nanotube and at least one second nanotube differ in at least one of structure and material. Further provided are processes for the manufacture of multilayered nanostructures and uses thereof.

### FIELD OF THE INVENTION

This invention relates to inorganic multilayered nanostructures, to methods of their preparation and uses thereof.

### BACKGROUND OF THE INVENTION

Layered compounds are compounds, the atoms of which are arranged in layers. One common example of such a compound is graphite, which is made of carbon atoms arranged in sheets. The atoms that make each sheet are bonded by covalent bonds, and the sheets are stacked together by van-der-Waals forces, which are much weaker than the covalent bonds.

Inside the sheet, each atom is bonded to a given “ideal” number of neighbors. At the edges of the sheet, the atoms do not have enough neighbors, and therefore, in some cases where the sheet is small enough, the sheet rolls such that atoms at one edge are bound to atoms of the opposing edge, thus forming a tubular structure, referred to as nanotube.

Inorganic fullerene-like nanostructures were described, for example, in WO9744278, and are discussed in detail in Nat. Nanotechnol. 2007, 1, 103-111.

U.S. Pat. No. 6,217,843, discloses a method for the preparation of nanoparticles of metal oxides containing inserted metal particles and metal-intercalated and/or metal-encaged “inorganic fullerene-like” (hereinafter IF) structures of metal chalcogenides obtained therefrom.

### SUMMARY OF THE INVENTION

The present invention provides a multilayered nanostructure comprising at least one first layered nanotube being of at least one first inorganic material and having an inner void holding at least one second layered nanotube being of at least one second inorganic material; wherein said at least one first nanotube and at least one second nanotube differ in at least one of structure and material.

As used herein the term “inorganic material” is meant to encompass inorganic materials, which do not consist of carbon atoms, capable of being arranged in stacked molecular layers (or sheets), forming two dimensional solids. For example, for an inorganic layered material such as MoS₂, it was observed that each molecular sheet of MoS₂ consists of a six fold-bonded molybdenum layer “sandwiched” between two three-fold bonded sulphur layers. The formed sheets (or layers) are held together via van der Waals forces. The molecular “rims” at the edges of such inorganic layered materials are capable of being folded to form a seamless stable nanotube structure having, in some embodiments a voided cavity, wherein all inorganic atoms are fully bonded. The term “nanotube” is meant to encompass a nanometer-scale tube-like structure having a cylindrical nanostructure wherein the length-to-diameter ratio is between about 10⁶ to about 10. (aspect ratio). Layered nanotubes may comprise between one to ten layers (i.e. 1, 2, 3, 4, 5, 6, 7, 8, 9, 10 layers) of nanotubes being of at least one inorganic layered material.

In some embodiments of the invention, said at least one first inorganic material has a general formula (I):

MₚXₙY_{q} (I)

wherein

M is a metal selected from an alkali metal, alkaline earth metal, transition metal, post-transition metal, metalloid, lanthanoid metal and actinoid metal;

X and Y are independently selected from N, O, P, B, S, halide, Se, and Te; and

n, p and q are integers each independently selected from 0, 1, 2, 3, 4 and 5.

In other embodiments of the invention, said at least one second inorganic material is of a general formula (II):

M′ₚX′ₙY′_{q} (II)

wherein

M′ is a metal selected from an alkali metal, alkaline earth metal, transition metal, post-transition metal, metalloid, lanthanoid metal and actinoid metal;

X′ and Y′ are independently selected from N, O, P, B, S, halide, Se, and Te; and

n, p and q are integers each independently selected from 0, 1, 2, 3, 4 and 5.

In some embodiments of the invention, M and M′ are each independently an alkali or alkaline earth metal selected from B, Cs, Rb, Mg, Ca, Cd and Ni.

In other embodiments, M and M′ are each independently a transition metal selected from W, Ni, Mo, V, Zr, Hf, Pt, Re, Nb, Ti and Ru.

In further embodiments, M and M′ are each independently a post-transition metal selected from Al, Ga, In, Sn, Ta, Pb and Bi.

In yet further embodiments, M and M′ are each independently a metalloid selected from B, Ge, Sb, Te and As.

In other embodiments of the invention, said at least one first and at least one second inorganic material are each independently selected from a group consisting of WS₂, MoS₂, PbI₂, BiI₃, SbI₃, CdI₂, NbS₂, MoCl₂, BN, V₂O₅, ReS₂, CdCl₂, CdI₂, NiBr₂, Ti₂O, Tl₂O, Cs₂O, PtO₂, NiPS₃, FePS₃, ZnAl₂O₄ and any combination thereof.

It is noted that at least one of the integers “n” or “q” in formulae (I) and/or (II) independently should be different than zero.

In other embodiments of the invention, said at least one first layered nanotube is being of at least two inorganic materials.

In further embodiments of the invention, said at least one second layered nanotube is being of at least two inorganic materials.

The term “halide” as used herein is meant to encompass a halogen atom such as for example F, Cl, Br, I and At.

When a nanotube is made from at least two inorganic materials, it should be noted that the ratio between said at least two inorganic materials may vary from 10⁶:1, 10⁵:1, 10⁴:1, 10³:1, 10²:1, 10:1, 5:1, 4:1, 3:1, 2:1, 1:1, 1:10⁶, 1:10⁵, 1:10⁴, 1:10³, 1:10², 1:10, 1:5, 1:4, 1:3, 1:2 of at least two inorganic layered materials. Said at least two inorganic materials may compose said at least one nanotube in a homogenous form (i.e. said nanotube has homogenous properties, throughout the nanostructured nanotube) or a heterogeneous form (i.e. said nanotube has heterogamous regions having different properties throughout the nanostructured nanotube).

In other embodiments said at least one first and/or at least one second inorganic material may be in the form of a nanorod, a nanocomposite, a nanocage, a nanofiber, a nanoflake, a nanoparticle, a nanopillar, a nanopin film, a nanoring, a nanorod or any combination thereof.

In some embodiments said at least one first and/or at least one second nanotube is has a closed-loop wall having at least two layers made of at least one inorganic layered material. The term “closed loop wall” is used to describe a wall that has at least one closed-curve cross-section.

When referring to at least one first nanotube and at least one second nanotube as being “differ in at least one of structure and material” is should be understood to encompass that said at least one first nanotube being made of at least one first inorganic layered material and said at least one second nanotube being made of at least one second inorganic layered material are mutually different in at least one aspect of structure and/or material. When difference resides in the materials used, each of said at least one first nanotube and said at least one second nanotube may be composed of at least one different inorganic layered materials. In other embodiments, each of said at least one first nanotube and at least one second nanotube may be composed of the same at least two inorganic materials, however each may have different ratios of said at least two inorganic layered materials.

In other embodiments when difference resides in the structural aspect of said at least one first nanotube and at least one second nanotube, each may be composed of the same at least one inorganic layered material, however at least one structural parameter of said inorganic layered material may be different, i.e. for example two different polymorphs of the same inorganic layered material or a different orientation layering of said at least one inorganic layered material.

When referring to a nanotube having an “inner void holding said at least one nanotube” is should be understood to encompass the inner most region or core achieved by said nanotube (being a single layer or having several layers) capable of holding said at least one second nanotube. In some embodiments said at least one first nanotube and at least one second nanotube are coaxial, i.e. are cocentric and share a common axis.

Thus, the term “multilayered nanostructure” is meant to encompass a nanostructure having at least two components, being at least one first layered nanotube (which may consist of between one to 10 layers (i.e. 1, 2, 3, 4, 5, 6, 7, 8, 9, 10 layers) being of at least one first inorganic material) and at least one second layered nanotube (which may consist of between one to 10 layers (i.e. 1, 2, 3, 4, 5, 6, 7, 8, 9, 10 layers) of at least one second inorganic material).

It should be understood that each of said at least one first and at least one second nanotubes may have a homogenous or heterogeneous surface. In some embodiments when said multilayered nanostructure comprises at least one first nanotube being of at least one first layered inorganic material (designated herein as “F”) and at least one second nanotube being of at least one second layered inorganic material (designated herein as “S”), said multilayered nanostructure may be of the following non-limiting layer ordering: “ . . . FFFF . . . SSSS . . . ”, “ . . . SSSS . . . FFFF . . . ”, “ . . . FSFSFSFS . . . ”, “ . . . SFSFSFSF . . . ”, “ . . . FFFF . . . SSSS . . . FFFF . . . ”, “ . . . SSSS . . . FFFF . . . SSSS . . .” and any combination thereof.

In some embodiments, a multilayered nanostructure comprises more than two coaxial nanotubes of mutually different inorganic layered compounds, for example, 3, 4, 10, or any intermediate number of nanotubes. In other embodiments, two nanotube of the same material are separated by a nanotube of a different compound. In other embodiments, one or more of the nanotubes is multi-walled.

In other embodiments, a multilayered nanostructure of the invention, has a core shell structure wherein said at least one first nanotube constitutes the shell and said at least one second nanotube constitutes the core. It should be understood that said shell may substantially encompass and encase said core. Additionally, said core may further encompass another at least one nanotube being of at least one inorganic layered material which differ in at least one of structure and material. Said core may, in some embodiments comprise a inner void region.

In one exemplary embodiment, a tungsten disulfide (WS₂) nanotube encases a lead iodide (PbI₂) nanotube. Such a structure is referred herein as PbI₂@WS₂ core-shell nanotube. In other embodiments, the WS₂ nanotube encases polycrystalline PbI₂. Other examples of core-shell inorganic nanotubes include BiI₃@WS₂; SbI₃@WS₂; WS₂@MoS₂, PbI₂@WS₂@PbA₂.

In another aspect of the invention there is provided a mulilayered nanostructure selected from the following list: PbI₂@WS₂, BiI₃@WS₂, SbI₃@WS₂, WS₂@MoS₂, PbI₂@WS₂@PbI₂, SbI₃@WS₂@SbI₃.

In some embodiments of the invention, said at least one first nanotube has a melting point higher than the melting point of said at least one second nanotube. In some embodiments of the invention, said at least one first nanotube has a melting point higher than the melting point of said at least one second inorganic material.

In yet other embodiments, said at least one second nanotube has a melting point higher than the melting point of said at least one first nanotube. In yet other embodiments, said at least one second nanotube has a melting point higher than the melting point of said at least one first inorganic material.

In other embodiments of the invention, said inner void of said at least one first nanotube has an internal diameter of at least 6 nm. In further embodiments, said inner void of said at least one first nanotube has an internal diameter of between about 6 to about 10 nm. It should be understood that dimensions of said void of said at least one first nanotube as mentioned hereinabove are measured for said at least one first nanotube by itself, without considering said at least one second inorganic nanotube held within said void of said at least one first nanotube.

In some other embodiments of the invention, said at least one first nanotube and at least one second nanotube have substantially similar ionicity values (%). In other embodiments, said ionicity values are between about 1 to 10%.

The below experiments show that the corresponding ionicity of said at least one first and at least one second nanotubes composed of inorganic materials influences the ability of materials to wet the template surface and enfold it to form (core-shell) INT. Table 1 summarizes the ionicity values for different exemplary inorganic materials.

It is stipulated that in a trilayer INT, the separation of iodine atoms on the outer layer of the sandwich I-M-I trilayer structure is larger than the equilibrium distance of the bulk (2H) atoms and therefore they are subdued to a tensile stress. Contrarily, the inner iodine atoms of the trilayer are closer than the equilibrium distance of the iodine atoms in the bulk material and they withstand a compressive stress. The residual negative charge on the iodine atoms of (the more ionic) CdI₂ is larger than that of PbI₂ (see Table 1). Consequently, the repulsion between the inner iodine atoms in a would-be INT-CdI₂ is stronger making the formation of a nanotube less favorable than the case of PbI₂. Furthermore, in the interface between the two nanotubes, the innermost sulfur atoms of WS₂ are in great proximity to the iodine atoms of the metal iodide compound. Hence, the more polar iodine atoms of CdI₂ are not likely to favor the vicinity to the non-polar sulfur atoms. It is assumed that the greater ionicity, or electronegativity difference a compound might have, it will less probably form an INT and in particular a core-shell nanotube structure. This conclusion is further supported by the fact that the inorganic compounds with the smallest ionicity (WS₂ and MoS₂) form the core-shell INT and IF with the highest yield and in particular core shell WS₂@MoS₂ or vice versa.

TABLE 1
The properties of the materials
discussed in the current work

| | Ionicity, % | Melting | Interlayer |
|---|---|---|---|
| Inorganic | Electronegativity | Point | distance |
| material | difference | ° C. | Å |
| WS₂ | 1% | 1250° C. | 6.162 Å |
| | 0.22 | (decomposes) | |
| MoS₂ | 4% | 1184° C. | 6.155 Å |
| | 0.42 | ref. | |
| PbI₂ | 2% | 410° C. | 6.979 Å |
| | 0.33 | | |
| BiI₃ | 9% | 408.6° C. | 6.910 Å |
| | 0.64 | | |
| SbI₃ | 9% | 168° C. | 6.672 Å |
| | 0.61 | | |
| CdI₂ | 22% | 387° C. | 6.864 Å |
| | 0.97 | | |
| NbS₂ | 22% | 1050° C. | 5.945Å |
| | 0.98 | (decomposes) | |

In a further aspect, the invention provides a use of a multilayered nanostructure as mentioned hereinabove, for the preparation of solid lubricant.

In a further aspect, the invention provides a use of a multilayered nanostructure as mentioned hereinabove, for the preparation of a radiation detector. In this respect, it is noted that this application may be achieved for example when the outer nanotube is “transparent” to the relevant spectrum.

In other aspects of the invention, there is provided a solid lubricant comprising at least one multilayered nanostructure of the invention.

In yet other aspects the invention provides a radiation detector comprising at least one multilayered nanostructure as mentioned hereinabove.

In another one of its aspects the invention provides a method of producing a multilayered nanostructure of the invention, said method comprising:

(a) providing a template nano structure comprising at least one first layered nanotube being of at least one first inorganic material, having an inner void;

(b) mixing said template with at least one second inorganic material or a precursor thereof;

(c) applying conditions on said mixture capable of constructing at least one second layered nanotube of at least one second inorganic material within said inner void of said template, thereby forming said multilayered nanostructure.

In some embodiments step (c) of above method may be repeated for at least two times.

It should be understood that construction of said at least one second nanotube of at least one second inorganic material within said inner void of said template may be performed by epitexially depositing said at least one second inorganic material. Such deposition may be homogenous or heterogeneous.

In some embodiments at least a part of the perimeters inner void of said template maybe covered by, or epitaxially deposited with said at least one second nanotube.

In an additional aspect of the invention, there is provided a method of producing a multilayered nanostructure of the invention, said method comprising:

(a) providing at least one first inorganic material or a precursor thereof;

(b) mixing said at least one first inorganic material with a template nanostructure comprising at least one second layered nanotube being of at least one second inorganic material ;

(c) applying conditions on said mixture to enable construction of at least one first layered nanotube of at least one first inorganic material on the outer surface of said template, thereby forming said multilayered nanostructure.

It should be understood that construction of said at least one first nanotube of at least one first inorganic material in the outer surface said template may be performed by epitexially depositing said at least one first inorganic material. Such deposition may be homogenous or heterogeneous.

In some embodiments at least a part of the outer perimeters of said template maybe covered by, or epitaxially deposited with said at least one first nanotube. In some other embodiments the entire outer perimeters of said template are epitaxially deposited with said at least one first nanotube.

In some embodiments, said conditions are selected from the group consisting of application of heat to said mixture, application of focused electron beam irradiation to said mixture and addition of at least one chalcogen to said mixture or any combination thereof.

In another one of its aspects the invention provides a method of producing a multilayered nanostructure of the invention, said method comprising:

(a) providing at least one first nanotube being of at least one first inorganic material;

(b) mixing said at least one first nanotube with at least one second inorganic material having a melting point lower than the melting point of said at least one first nanotube;

(c) applying heat to said mixture above the melting point of said at least one second inorganic material; and

(d) cooling heated mixture to obtain said multilayered nanostructure.

It is noted that the construction of at least one second nanotube of at least one second inorganic material may be deposited in the inner void of said at lease one nanotube and/or on the outer surface of said at least one nanotube. The construction of said multilayered nanostructure may be homogenous of heterogeneous.

In some embodiments, said application of heat is carried out for a period of between 2-240 hours. In some embodiments heat is carried out for a period of 4, 5, 6, 7, 8, 9, 10, 15, 20. 25, 30, 35, 40, 45, 50, 55, 60, 70, 80, 90, 100, 120, 150, 200, 240.

In other embodiments, said cooling is applied either by quenching of said heated mixture or by gradually lowering of temperature of said heated mixture.

In a further aspect the invention provides a method of producing a multilayered nanostructure of the invention, said method comprising:

(a) providing at least one first nanotube being of at least one first inorganic material;

(b) mixing said at least one first nanotube with at least one second inorganic material having a melting point lower than the melting point of said at least one first nanotube;

(c) applying focused electron beam irradiation to said mixture; and

(d) cooling heated mixture to obtain said multilayered nanostructure.

In the context of the above noted method, it is noted that said focused electron beam may directed to the inner void of said at least one first nanotube, thereby enabling construction and/or deposition of said at least one second nanotube being of said at least one second inorganic material in the inner void of said at least one first nanotube. In other embodiments, said focused electron beam is directed to the outer surface of said at least one first nanotube, thereby enabling construction and/or deposition of said at least one second nanotube being of said at least one second inorganic layered material on the outer surface of said nanotube.

It is noted that the construction of at least one second nanotube of at least one second inorganic material may be in the inner void of said at lease one first nanotube and/or on the outer surface of said at least one first nanotube. The construction of said multilayered nanostructure may be homogenous of heterogeneous.

In yet a further aspect the invention provides a method of producing a multilayered nanostructure of the invention, said method comprising:

(a) providing at least one first nanotube being of at least one first inorganic material;

(b) mixing said at least one first nanotube with at least one inorganic precursor of at least one second inorganic material to obtain an initial reaction mixture;

(c) adding at least one chalcogen to said initial reaction mixture to obtain a final reaction mixture;

(d) applying heat to said final reaction mixture capable of gasifying said at least one inorganic precursor and at least one chalcogen; and

(e) cooling heated mixture to obtain said multilayered nanostructure.

In some embodiments of methods of the invention each method step may be repeated at least one to 10 times.

In some embodiments, said at least one inorganic precursor is a halide or carbonyl derivative of a metal selected from of alkali metal, alkaline earth metal, transition metal, post-transition metal and metalloid.

In further embodiments, inorganic precursor is selected from MoCl₅.

In other embodiments, said chalcogen (or a chalcogenide precursor) is selected from S, Se, Te, Po, H₂S or any combination thereof.

In yet other embodiments, a method of the invention as provided herein above further comprising application of heat to initial reaction mixture capable of gasifying at least one inorganic precursor.

It is noted that the construction of at least one second nanotube of at least one second inorganic material may be in the inner void of said at lease one first nanotube and/or on the outer surface of said at least one first nanotube. The construction of said multilayered nanostructure may be homogenous of heterogeneous.

In further embodiments of a method of the invention, said at least one first inorganic material is selected from WS₂, MoS₂, PbI₂, BiI₃, SbI₃, CdI₂, NbS₂, MoCl₂, BN, V₂O₅, ReS₂, CdCl₂, CdI₂, NiBr₂, Ti₂O, Tl₂O, Cs₂O, PtO₂, NiPS₃, FePS₃ and any combination thereof.

In some embodiments, said method of producing a multilayered nanostructure of the invention comprise chemical vapor transport (CVT). In one example, CVT comprises providing an ampoule having inorganic nanotubes of at least one first material at one end of the ampoule and inorganic coating material at the other. A transport agent (usually halogen or volatile halide) is added as well. Then, the ampoule is put under a temperature gradient going from 850° C. at the nanotubes-containing end of the ampoule to 900° C. at the coating-material-containing end of the ampoule. Keeping the system under these conditions for long enough (for example, two weeks), allows growth of a nanotube of the coating material over the provided nanotubes, to form core-shell structure

In other embodiments, said method of producing a multilayered nanostructure of the invention comprise carrying out the process in a flow system. In one such example, at least one nanotube is placed in a hot zone of a furnace. Two flows of reactants are directed to said nanotube: one flow of a chalcogenide precursor and one flow of an inorganic precursor. The two flows are directed to said nanotube such that the reactants react with each other only in the vicinity of the nanotubes. At said nanotube, the two precursors react with each other so as to coat said nanotube with an outer metal chalcogenide nanotube. In some embodiments, prevention of a chemical reaction between the two reactants away from the nanotubes is achieved by directing each reactant flow in a distinct tube. In other embodiments, one or both of the reactant flows comprise an inert gas carrier, for instance, nitrogen.

In some embodiments, WS₂ nanotubes serve as a template over which closed layers of MoS₂ grow to form a core-shell WS₂@MoS₂ nanotube structure, i.e. MoS₂ nanotube encasing WS₂ nanotube.

Nanostructures prepared according to various embodiments of the invention may be single-walled or multi-walled. In some embodiments, all the nanotubes are multi-walled. In some embodiments, one or more of the nanotubes making the nanostructure are single-walled, and the rest multi-walled. In some embodiments, all the nanotubes are single walled.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is a schematic illustration of an inorganic nanotube according to an embodiment of the invention;

FIG. 1B is a model of a nanotube made of a layer having a first chiral angle encasing a nanotube made of a layer having a second chiral angle;

FIG. 2A is a flowchart of actions taken in a method of making a nanotube according to an embodiment of the invention;

FIG. 2B is a flowchart of actions taken in another method of making a nanotube according to an embodiment of the invention;

FIG. 2C is a schematic illustration of a flow system 70 suitable for carrying out a method as described in FIG. 2B

FIGS. 3A-3B are TEM image and line profile obtained from a portion of a core-shell PbI₂@WS₂ nanotube according to an embodiment of the invention;

FIGS. 4A and 4B are EELS and EDS spectra, respectively, of the core-shell nanotubes of FIGS. 3A-3B;

FIG. 5A is a TEM image of a WS₂@MoS₂ core-shell structure according to an embodiment of the invention;

FIG. 5B is the EELS spectrum of a similar structure;

FIG. 5C is the EDS spectrum of a similar structure, with the molybdenum peaks marked with arrows and

FIG. 6 is HRTEM image showing a WS₂@MoS₂ core-shell structure according to an embodiment of the invention.

FIG. 7A. is a HRTEM image of a core-shell PbI₂@WS₂ INT obtained by the wetting and capillary filing as described in Example 3. Arrows show the growth of inner PbI₂ nanotubes from the melt; note the concave meniscus formed at the receding front of the nanotube, which is indicative of a good wetting.

FIG. 7B shows the line profile corresponding to the framed area, showing the two types of nanotube layers.

FIG. 8A shows a HRTEM image of a core-shell BiI₃@WS₂ INT obtained by the wetting and capillary filing as described in Example 3.

FIG. 8B is the corresponding line profile from the framed area in FIG. 8A

FIG. 8C is a HRTEM image of another core-shell BiI₃@WS₂ INT obtained by the wetting and capillary filing as described in Example 3.

FIG. 8D is an EDS spectrum of BiI₃@WS₂ INT shown in FIG. 8C that exhibits signals corresponding to tungsten, sulfur, bismuth and iodine, indicating the composition of the core-shell INT (The copper and carbon signals originate from the TEM grid).

FIG. 9 shows a HRTEM image of a BiI₃ nanotube adjacent to a BiI₃ nanorod formed inside the tubular cavity of an oblique-shaped WS₂ INT.

FIG. 10 shows close-caged PbI₂ nanoparticles acquired in situ via electron beam irradiation of PbI₂ powder in the presence of INT-WS₂ in the TEM.

FIG. 11A is a TEM image of a SbI₃@WS₂@SbI₃ core-shell inorganic nanotube acquired via in situ electron beam irradiation in a TEM.

FIG. 11B is a TEM image of a SbI₃@WS₂@SbI₃ core-shell inorganic nanotube acquired via in situ electron beam irradiation in a TEM; arrows indicate SbI₃ layers.

FIG. 11C is a typical EDS spectrum of SbI₃@WS₂@SbI₃ core-shell inorganic nanotube of FIGS. 11A-11B showing signals due to tungsten, sulfur, antimony and iodine.

FIG. 11D is a line profile taken from the framed area in FIG. 11A.

FIG. 12A shows a TEM image demonstrating the intermediate stages of SbI₃@WS₂@SbI₃ INT synthesis by in situ electron beam irradiation in a TEM, wherein complete wetting and filling of WS₂ INT by SbI₃ is shown.

FIG. 12B shows a TEM image demonstrating the intermediate stages of SbI₃@WS₂@SbI₃ INT synthesis by in situ electron beam irradiation in a TEM, wherein the outer and inner SbI₃ layers formation from the amorphous matter.

FIGS. 13A-13C show the WS₂@MoS₂ core-shell INT formed via a 2-step process; X-Ray Diffraction spectra of: the sample after reaction with molybdenum penta-chloride (FIG. 13A); the final sulfidized product (FIG. 13B). Triangles symbolize MoO₂ peaks and diamond shapes-WS₂/MoS₂. FIG. 13C shows the HRTEM image of the product. Inset is the TEM image of the product in an intermediate stage.

Scheme 1 is a schematic illustration of the formation mechanism of core-shell INT via capillary wetting experiment. The template nanoparticles are INT-WS₂, whereas the filling material is a low melting point layered metal halide marked as ABₓ (Here, ABₓ=PbI₂, BiI₃).

Scheme 2 is a schematic illustration of the formation mechanism of core-shell INT via in-situ electron beam irradiation in TEM. The template nanoparticles are INT-WS₂, whereas the filling material is SbI₃.

Scheme 3 is a schematic illustration of the formation mechanism of core-shell INT via a gas phase reaction. The template nanoparticles are INT-WS₂, whereas the reaction product is MoS₂.

### DETAILED DESCRIPTION OF EMBODIMENTS

This invention relates, in some embodiments thereof, to inorganic nanotubes, and more particularly but not exclusively, to inorganic nanotubes of layered compounds, such as tungsten disulfide.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways, for example a core-shell fullerene-like structure, for instance, WS₂@MoS₂ (fullerene-like MoS₂ on top of a similar WS₂ nanoparticle) or fullerene-like MoS₂@WS₂ core-shell nanostructure.

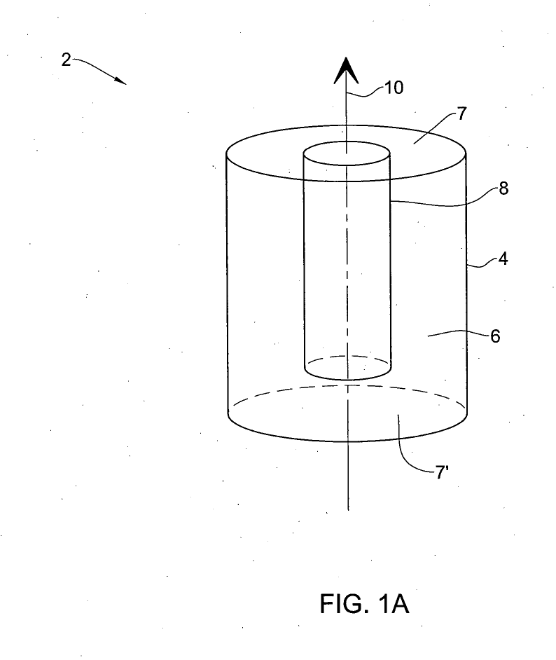

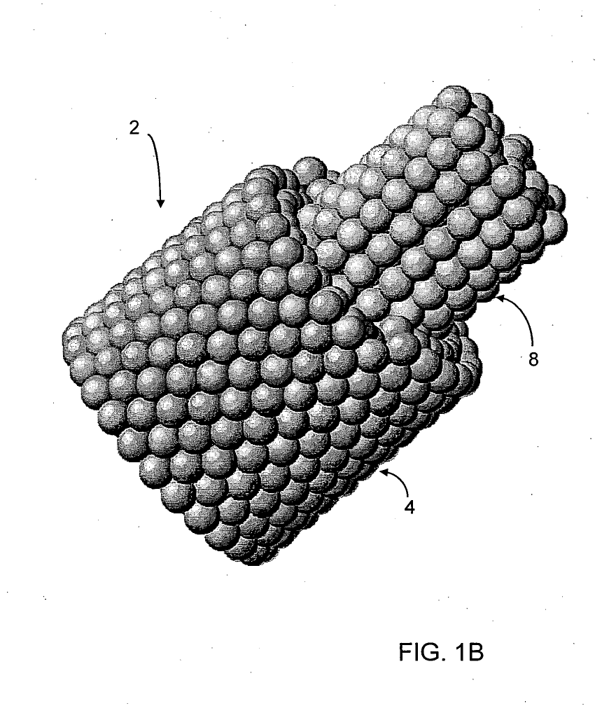

FIG. 1A is a schematic illustration of a nanostructure (2) according to an exemplary embodiment of the invention. FIG. 1B is a model of a nanostructure (2) according to an embodiment of the invention. Nanostructure 2 has walls (4) made of a first inorganic layered compound. Walls 4 define a luemn 6. Lumen 6 is optionally open ended, such that particles can enter luemn 6 through end 7 (or 7′) of the lumen. Walls 4 encase an inner nanotube 8 made of a second inorganic layered compound.

Nanotube 2 has a shape of a cylinder having a base 7 and parallel walls 4 going around a longitudinal axis 10. Optionally, longitudinal axis 10 is substantially perpendicular to base 7. Base 7 is shown circular. In some embodiments, base 7 is oval.

In some embodiments, a nanotube is made of a number of portions; and in each portion the direction of axis 10 is different. In some embodiments, axis 10 is curved, such that the nanotube is banana-like.

In exemplary embodiments, the length of the outer nanotube is about 0.05-500 microns optionally about 0.05-20 microns. In some embodiments, the diameter of the outer nanotube is 5-150nm, for example about 15-30 nm.

In exemplary embodiments, the cross-sectional dimension (e.g. diameter) of luemn 6 is about 15-120 nm, optionally about 20-50 nm.

Walls 4 of the outer nanotube and the walls of nanotube 8 are drawn in FIG. 1 to be of negligible thickness. However, in many embodiments, the thickness of the walls is of about the same order as the inner diameter of luemn 6. In some embodiments, the outer wall of the inner nanotube lies on the inner wall of the outer nanotube.

As noted hereinabove, nanotube (2) has walls made of a first inorganic compound and encases an inner nanotube 8 made of a second inorganic compound. In some preferred embodiments, the first and second inorganic compounds, of which the walls of the outer and inner nanotube are made, are layered compounds.

A layered compound is a compound, the atoms of which are arranged in layers. While strong chemical bonds operate between the atoms within the layer, the layers are stacked together by weak (usually van der Waals) interactions. Preferably, closed-loop bodies made of layered compounds are seamless. Optionally, each of the layers is a structure having two large dimensions (hereinafter, length and width), and one small dimension (hereinafter thickness), wherein each of the large dimensions is at least 10 times larger than the small dimension.

Some examples of layered compounds include boron nitride (BN); bismuth iodide (BiI₃); vanadium oxide (V₂O₅); lead iodide (PbI₂); cadmium iodide (CdI₂); nickel dichloride (NiCl₂); and tin sulfide (SnS₂/SnS). The term “layered compounds” is used herein also to encompass elements having at least one layered allotrope, for example phosphorous (P); boron (B) and bismuth (Bi).

Additional examples of layered compounds include compounds of the formula MXₙ, wherein M is metal and X is a chalcogenide selected from S, Se, and Te; and n represents the ratio between the number of metal atoms and chalcogenide atoms in the compound. Optionally, n is an integer, for example, 1, 2, 3, or 4. Preferably, M is In, Ga, Sn, or a transition metal, for example, W, Mo, V, Zr, Hf, Pt, Re, Nb, Ta, Ti, and/or Ru.

Additional examples of layered compounds include binary compounds, for example, Ti₂O; Tl₂O; Cs₂O and PtO₂ and ternary compounds, for example NiPS₃, and FePS₃.

In an exemplary embodiment, the atoms constituting each of the nanotubes are fully coordinated, such that the walls do not include dangling bonds. These nanotubes appear as seamless (nano)structure made from an inorganic layered compound.

Optionally, the compound of nanotube 8 is independent of the compounds of which walls 4 are made. Alternatively or additionally, it may be easier to obtain coaxial nanotubes when the inner space of an outer nanotube is large enough to accommodate a nanotube of the second compound without requiring the second compound to “pay” in strain energy more than about 0.5 eV/atom.

Optionally, the outer nanotube is a multi-wall nanotube. Additionally or alternatively, the inner nanotube is a multi-wall nanotube.

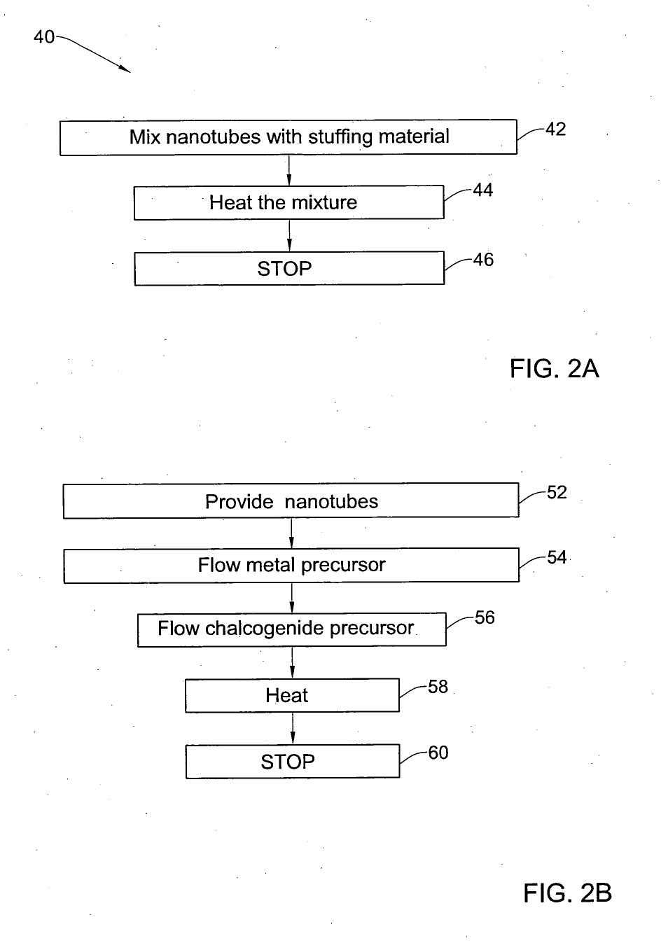

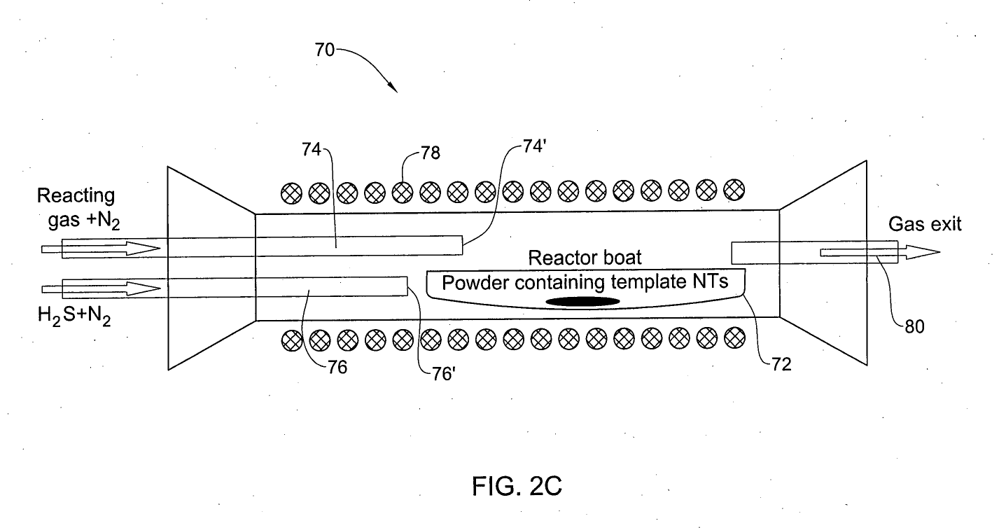

FIG. 2A is a flowchart of actions taken in a method 40 of making an inorganic nanotube of a first layered compound, said nanotube encasing a nanostructure of a second layered compound.

At 42, nanotubes of the first compound are mixed with particles, for instance, powder, of the second compound to obtain a mixture. This mixing optionally comprises grinding, for instance, with mortar and pestle. Optionally, the mixture also contains nanoparticles of the first compound that are not tubular.

At 44, the mixture obtained at 42 is heated to obtain the required inorganic nanostructure. Optionally, the heating is under vacuum, so as to prevent reaction of the layered compounds with oxygen, water, or other reactive components that may exist in the air. In some embodiments, the first and/or second layered compound might dissociate due to the vacuum and/or heating. In such embodiment it may be beneficial to heat the mixture in the presence of one or more of the possible dissociation products, to reduce or prevent the dissociation.

Heating is optionally to a temperature that is above the melting point of the stuffing material. In some embodiments, the stuffing material is volatile, and in such cases it may be beneficial not to heat much above the melting point pf the stuffing material, to limit such evaporation as much as possible. In case the stuffing material is PbI_{2 or BiI}₃, for instance, temperature of about 500° C. was found suitable.

Optionally, heating is for a period of between a few hours to a few weeks. Optionally, several heating times can be tried, and if no stuffed nanotubes are formed, heating period is increased. While shorter heating periods are usually preferred, in some embodiments longer heating periods are required in order to obtain higher yield of stuffed nanotubes, and/or nanotubes of higher quality.

At 46 heating is stopped. Optionally, heating is stopped after a few hours, optionally, heating is stopped after 2-10 days. In one exemplary embodiment, heating for a period of 30 days was found to produce yield of about 10% and high quality nanotubes of PbI₂@MoS₂. Optionally, the heating products are left in the furnace after the furnace is shut off, to allow the products to cool gradually in the shut-off furnace. Additionally or alternatively, after the furnace is shut off, the heated mixture is quenched, for example, with water/ice mixture.

FIG. 2B is a flowchart of actions taken in a method 50 of making an inorganic nanotube of a first layered compound, said nanotube encasing a nanostructure of a second layered compound. Method 50 is carried out in a gas flow system.

At 52, template inorganic nanotubes of layered compounds are provided;

At 54, a gas flow containing a metal precursor is brought to the vicinity of the template nanotubes, and another containing a chalcogenide precursor;

At 56, a gas flow containing a chalcogenide precursor is brought to the vicinity of the template nanotubes;

At 58 the gas flows and the nanotubes are heated; and

At 60 the heating and/or gas flow are stopped.

Preferably, actions 54, 56, and 58 are carried out simultaneously.

FIG. 2C is a schematic illustration of a flow system 70 suitable for carrying out a method as described in FIG. 2B. Flow system 70 includes a reactor boat 72, for holding powder containing template nanotubes. The reactor is open to receive gas flows from tubes 74 and 76, and to let gas exit through an outlet 80. Tube 74 is connected to a first gas source (not shown), providing the system with metal precursor, optionally carried with an inert carrier, for example, nitrogen.

Tube 76 is connected to a second gas source (not shown), providing the system with chalcogenide precursor, optionally carried with an inert carrier, for example, nitrogen.

Tubes 74 and 76 have exits (74′ and 76′, respectively) in the vicinity of reactor bath 72.

System 70 also includes heater 78, for heating reactor boat 72 and tubes 74 and 76.

In operation, template nanotubes are provided in reactor boat 72, gas flows of the metal precursor and of the chalcogenide precursors are provided to the vicinity of the nanotubes through tubes 74 and 76, and heater 78 is turned on. Optionally, the heater is turned on before the gas flows are provided, or when gas already flows in one or both of tubes 74 and 76.

In some aspect of the invention there is provided a nanostructure comprising a first inorganic nanotube made of a first layered compound and a second inorganic nanotube made of a second layered compound encased by said first inorganic nanotube, the first and second layered compounds being mutually different.

In some embodiments said first and second nanotubes are coaxial.

In other embodiments the first layered compound is selected from the following: boron nitride (BN); vanadium oxide (V₂O₅); calcium fluoride (CaF₂); lead iodide (PbI₂); bismuth iodide (BiIlᵢ) and a compound of the formula MXₙ, wherein M is metal; X is selected from S, Se, and Te, and n is selected from 1, 2, 3, and 4; Ti₂O, Ti₂O, Cs₂O; PtO₂, NiPS₃; and FePS₃.

In yet further embodiments M is selected from the following: In, Ga, Sn, W, Mo, V, Zr, Hf, Pt, Re, Nb, Ta, Ti, and Ru.

In some embodiments said second layered compound is selected from the following: boron nitride (BN); vanadium oxide (V₂O₅); calcium fluoride (CaF₂); lead iodide (PbI₂); bismuth iodide (BiI₂) and a compound of the formula MXₙ, wherein M is metal; X is selected from S, Se, and Te, and n is selected from 1, 2, 3, and 4; Ti₂O, Tl₂O, Cs₂O; PtO₂, NiPS₃; and FePS₃.

In other embodiments a nanostructure of the invention has a length of between 0.05-500 microns

In other embodiments a nanostructure of the invention has an inner lumen, said lumen having a cross-sectional dimension of 15 nm to 120 nm.

In some other aspects the invention provides a nanostructure comprising a first inorganic nanotube made of a first layered compound and a second inorganic nanotube made of a second layered compound and being encased by the first nanotube, wherein the first and second layered compounds are mutually different.

In other aspects the invention provides a method of making a nanostructure comprising an inorganic nanotube of a first compound encasing a nanostructure of a second compound, the method comprising:

(a) mixing nanotubes of the first compound with particles of the second compound to obtain a mixture; and

(c) heating the mixture thereby obtaining an inorganic nanotube of the first compound encasing a nanostructure of the second compound.

In some embodiments said mixing comprises grinding.

In other embodiments said method of the invention comprises applying a pressure to said mixture during said heating. In some embodiments of the invention said pressure is 0.01 microbar. In other embodiments said heating is carried out to a temperature of above the melting point of the second compound. In other embodiments, said heating is carried out for a period of 30 days.

According to another aspect of the invention there is provided a method of making an inorganic nanostructure comprising a nanotube of a metal chalcogenide encasing a nanotube of a second compound, different from said metal chalcogenide, the method comprising:

(a) providing nanotubes of the second compound; and

(b) reacting, in the gas phase, a metal or metal containing compound with a chalcogenide or chalcogenide containing compound, said reacting being in the presence of said provided nanotubes.

In some embodiments said metal containing compound is metal chloride or metal carbonyl. In other embodiments said metal is selected from In, Ga, Sn, W, Mo, V, Zr, Hf, Pt, Re, Nb, Ta, Ti, and Ru. In other embodiments said second compound is a metal chalcogenide. In other embodiments said metal chalcogenide obtained in the reaction is one of WS₂ and MoS₂ and the second compound is a different one of WS₂ and MoS₂.

In some embodiments a method as described hereinabove further comprises: (c) reacting, in the gas phase, a metal or metal containing compound with sulfur or sulfur containing compound, said reacting being in the presence of the nanostructure obtained in the former reacting action. In some embodiments said method comprises repeating step (c) between 2 and 10 times.

Various embodiments and aspects of the present invention find experimental support in the following examples.

### EXAMPLE 1

### PBI₂@WS₂

A sample of multi-wall (4-10 walled) WS₂ nanotubes was synthesized using a fluidized bed reactor according to a procedure described at R. Rosentsveig, A. Margolin, Y. Feldman, R. Popovitz-Biro, R. Tenne, Chem. Mater. 2002, 14, 471-473.

30 mg of a mixture containing about 5% multi-wall WS₂ nanotubes and Fullerene-like WS₂ nanoparticles obtained in the aforementioned synthesis was mixed with 120 mg of PbI₂ (Alfa Aesar, 98.5%, m.p. 402° C.) and ground using a mortar and pestle and transferred to a silica quartz ampoule. Then ca. 15 mg crystalline iodine (Alpha Aesar, 99.5%) was added to the ampoule, to reduce or prevent possible dissociation of PbI₂, and pumped to high vacuum (˜10⁻⁵ mbar). The ampoule was sealed under the low pressure, and inserted to a pre-heated furnace, where it dwelled at 500° C. for 30 days followed by slow overnight cooling to room temperature.

The product was sonicated in ethanol, placed on a carbon/collodion-coated Cu grid, and analyzed by TEM (Philips CM-120, 120 kV); STEM (JEOL JEM-3000F field emission gun, 300 kV, low-pass Butterworth filter); and HRTEM (FEI Tecnai F-30 with EELS or JEOL JEM-3000F field emission gun, 300 kV). Images were acquired digitally on a Gatan model 794 (1k×1k) CCD camera, the magnification of which was calibrated with Si [110] lattice spacing. EDS was performed with an electron probe 0.5 nm in diameter.

The samples were examined by high resolution transmission electron microscopy (HRTEM); energy dispersive X-ray spectroscopy (EDS); electron diffraction (ED); and electron energy loss-spectroscopy (EELS). HRTEM images and the corresponding details were obtained close to ideal Scherzer imaging conditions.

The majority of the WS₂ nanotubes were found to contain filling following one month heating.

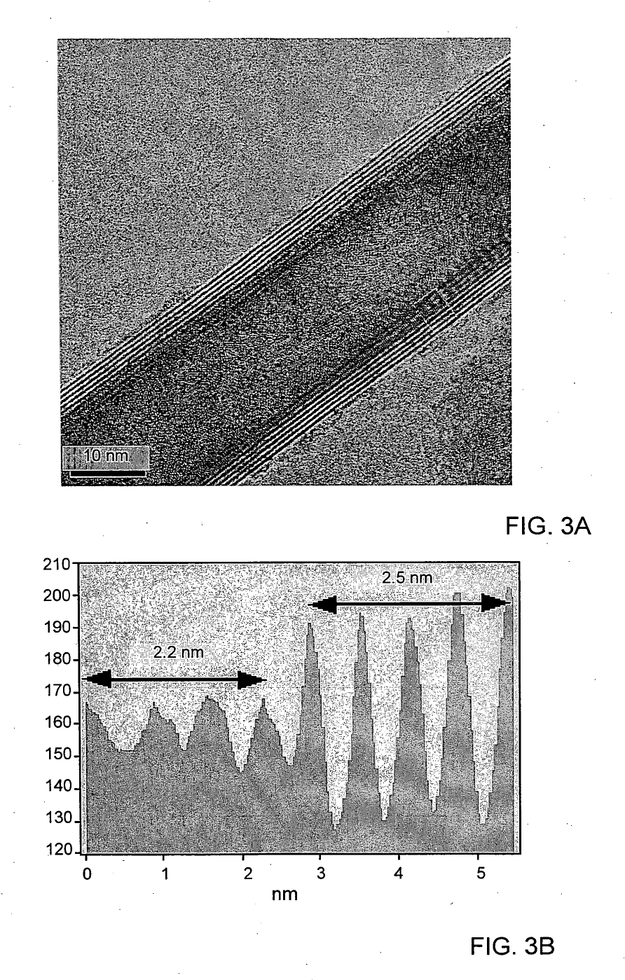

The majority of the PbI₂ filling revealed formation of inner PbI₂ inorganic nanotubes inside the WS₂ nanotubes, which served as templates. FIGS. 3A-3B show typical results obtained from a portion of a core-shell PbI₂@WS₂ nanotube, in which the encapsulated PbI₂ layers conformably cover the inner core of the host nanotubes. It was further found that longer (two weeks to one month) heating periods of the sample leads to more perfect conformal lining of the WS₂ outer shell. The encased PbI₂ inside WS₂ nanotubes showed, in addition to the nanotubular structure, both amorphous and non-tubular crystalline filling.

FIG. 3A is a TEM micrograph showing a core-shell PbI₂@WS₂ composite nanotube obtained in the above procedure.

FIG. 3B is a line profile obtained from the region indicated in FIG. 3A. The line profile is showing two types of nanotube layers: five ‘outer’ WS₂ layers with sharper contrast and an average spacing of 0.63 nm and three ‘inner’ layers with more complex contrast and an average spacing of 0.70 nm, corresponding to three concentric PbI₂ nanotubes.

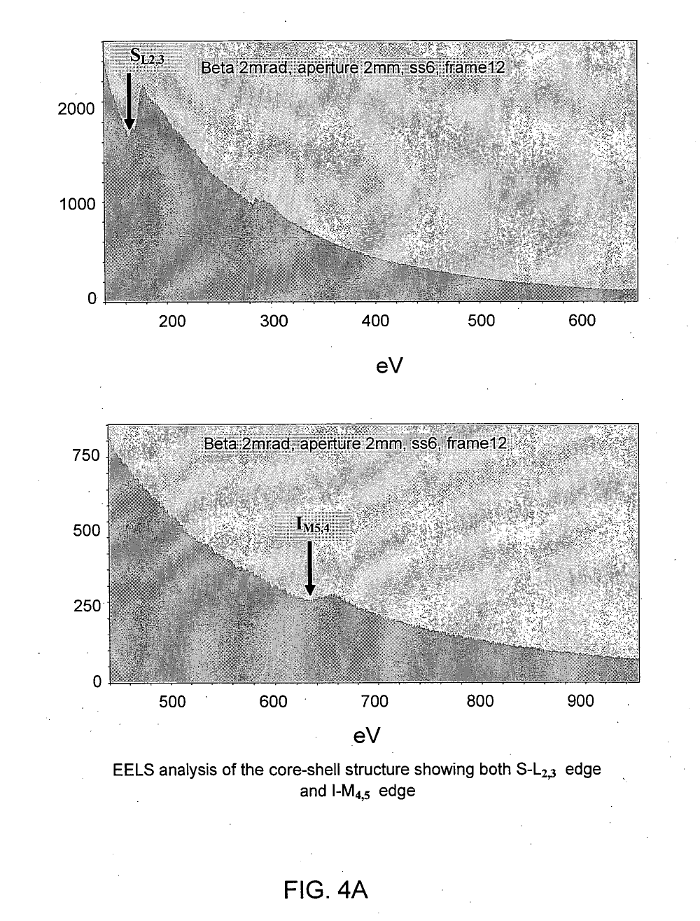

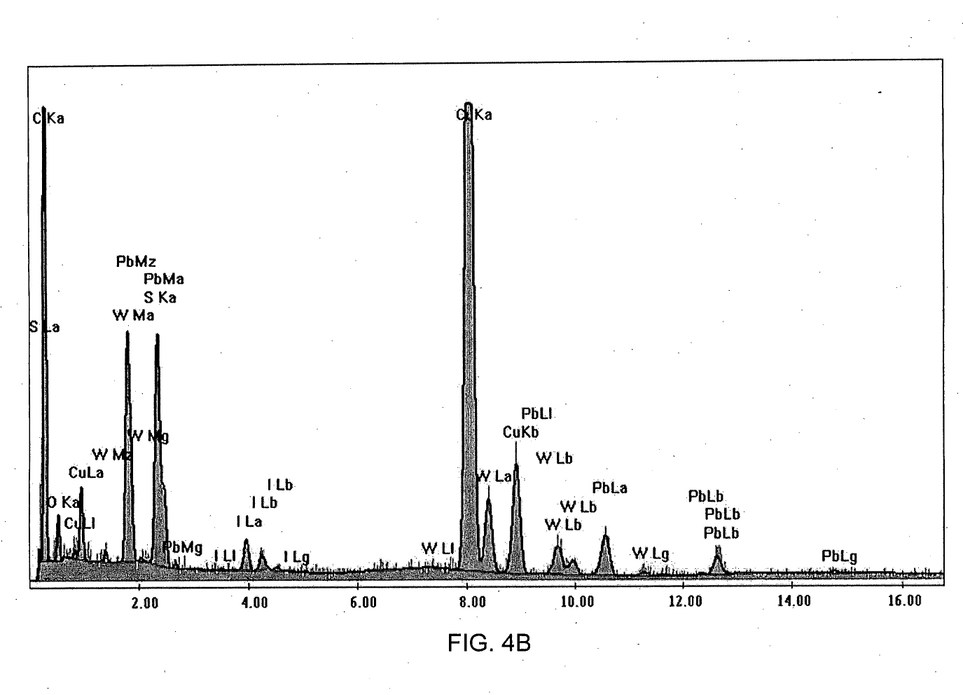

FIGS. 4A and 4B are EELS and EDS specta of the nanostructures obtained in the above-described process. EELS and EDS analysis complementarily confirmed the presence of W, S, Pb and I constituting elements of the obtained core-shell inorganic nanotubes. As can be seen in FIG. 4A, the EELS spectrum revealed both the S-L2,3 and the I-M4,5 edges. As can be seen in FIG. 4B, the S_{kα} is overlapping with Pb_{Mα}, but the Pb_{Lα} is clearly visible. Since the inner diameter of the WS₂ nanotube is relatively constant at about 10-12 nm, the number of PbI₂ layers in these core-shell structures is limited to about 3 to 5. The typical length of the inner PbI₂ nanotubes did not exceed a few 100 nm, and the smallest diameter of inner PbI₂ nanotubes was found to be approx. 3 nm.

### EXAMPLE 2

### WS₂@MoS₂

The inventors found that when a gas-phase reaction between a metal precursor and a chalcogenide precursor is carried out in the vicinity of nanotubes under suitable conditions, layered metal dichalcogenide coat the nanotubes to form core-shell nanotubes.

Preferably, the precursors are volatile at the reaction conditions. Examples of suitable metal precursors include metal chlorides and metal carbonyls. Examples of suitable metals include In, Ga, Sn, W, Mo, V, Zr, Hf, Pt, Re, Nb, Ta, Ti, and Ru.

Examples of chalcogenide precursors include sulfur, H₂S, Te, and Se.

The metal precursor and the chalcogenide precursor are fed to the ampoule and mixed with the template inorganic nanotubes. Optionally, the precursors are fed in stoichiometric amounts. It is sometimes preferable to provide an excess of the chalcogenide precursor to compensate for loss during heating.

After pumping to create vacuum of 10⁻⁴-10⁻⁶ and sealing, the sample is thermally treated at temperature suitable for reaction between the precursors. Two alternative gas phase reactions that are optionally used for synthesis are chemical vapor transport (CVT) and a gas phase reaction in a flow system.

In a specific experiment 30 mg of WS₂ nano-particualte powder was mixed with 137 mg MoCl₅ (95% Aldrich) and 112 mg sulfur (99.98% Sigma Aldrich). The great sulfur to metal chloride ratio (7:1) was intended to insure MoS₂ formation. The details of the evacuation, sealing and TEM grid preparation are similar to the procedure described hereinabove. The sample was thermally treated at 800° C. for 6 hr followed by a slow overnight cooling.

An alternative route included a two step process: in the first step, a reaction between 30 mg of the WS₂ nanoparticualte powder and 137 mg of MoCl₅ at 700° C. was carried out in a sealed quartz ampoule. The ampoule was broken and the product was collected and grinded. Subsequently, sulfur, in yet a grater ratio to the metal chloride (200 to mg ratio), was added and the mixture was pumped and sealed in a new ampoule, following a treatment at 500° C. The rest of the experimental details remained unchanged. The products of each step were examined by X-ray diffraction (XRD) using an Ultima 3 Rigaku X-ray diffractometer. The data was analyzed with the assistance of MDI Jade 7.0 program.

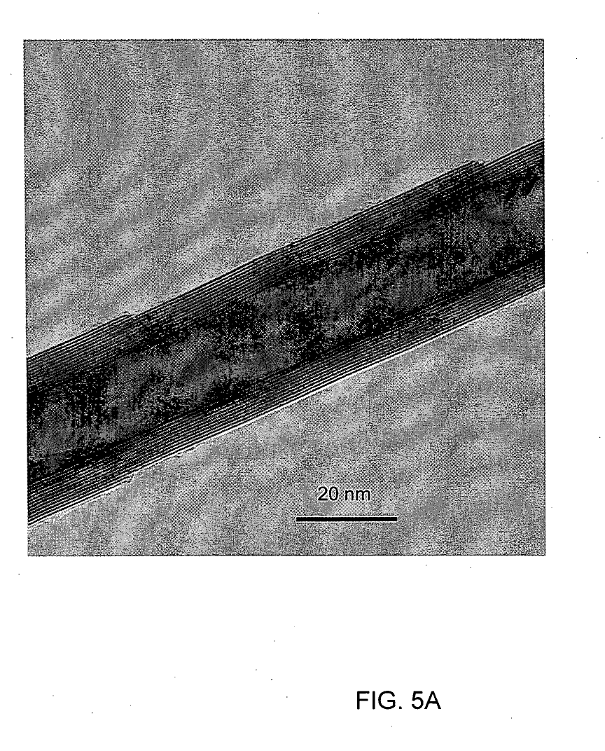

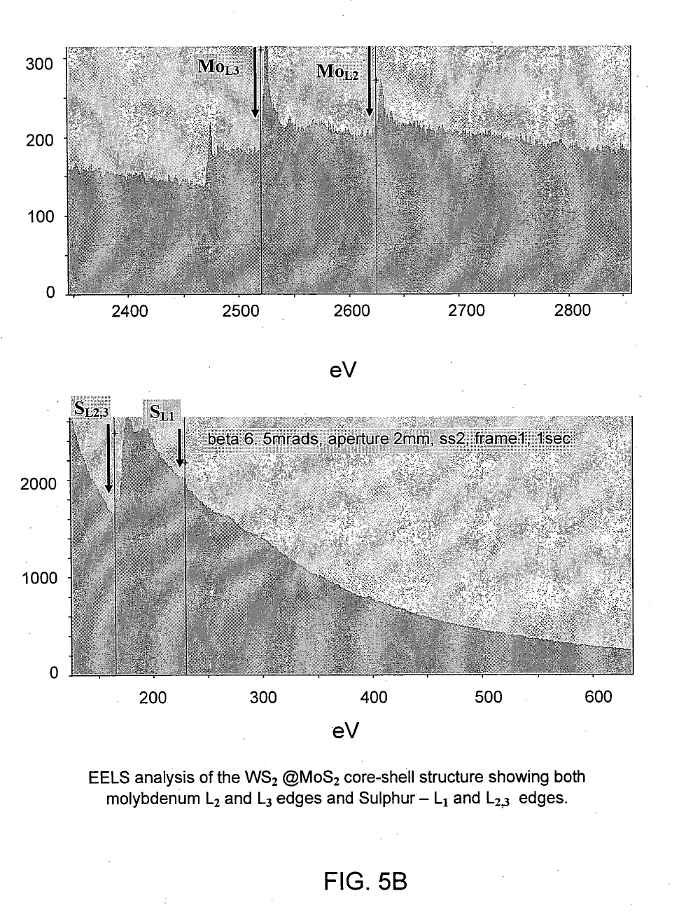

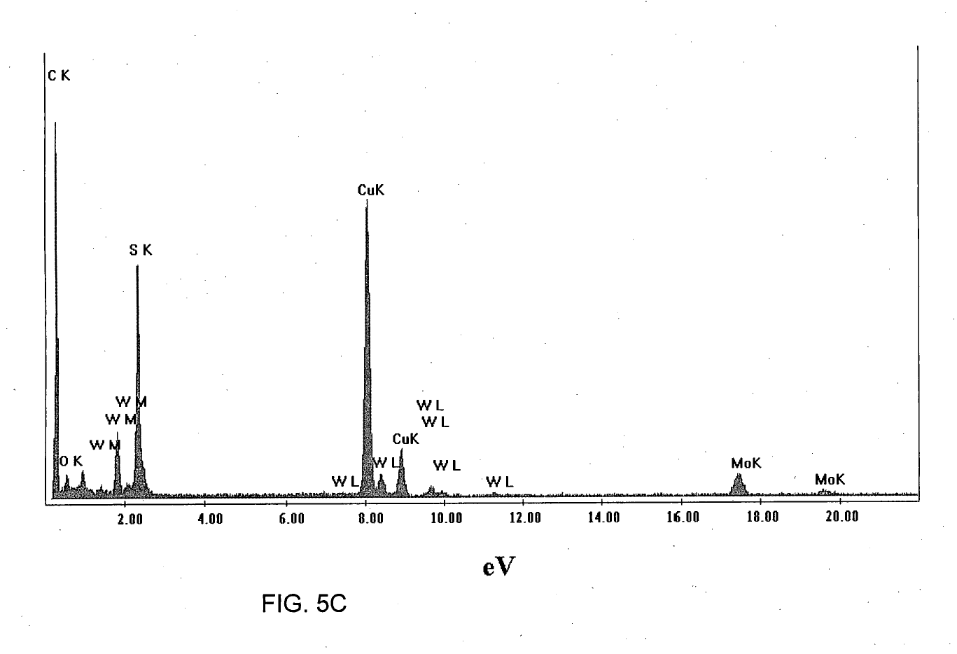

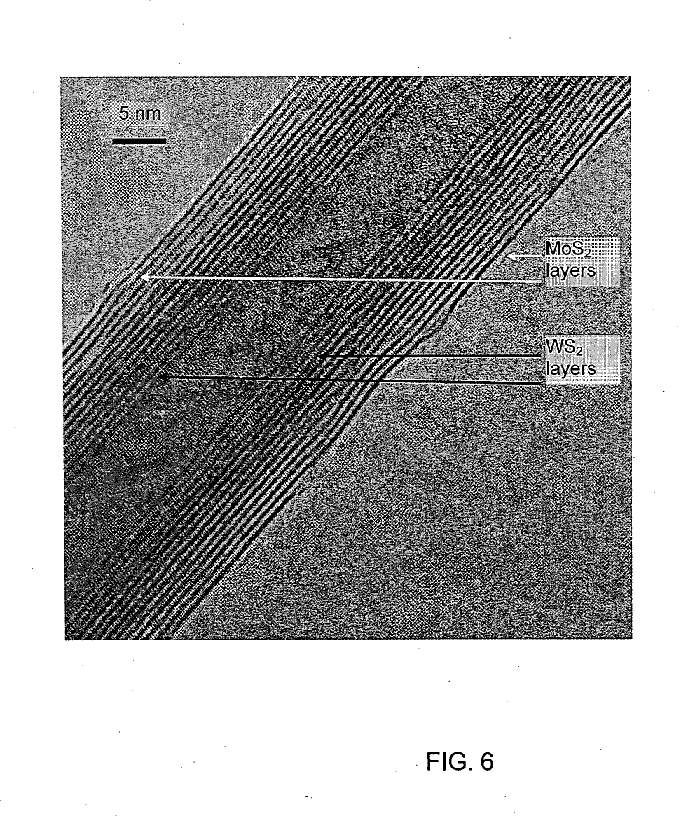

Conformal coating of the MoS₂ layers atop template INT-WS₂ leaded to WS₂@MoS₂ core-shell INT. These core-shell nanotubes were obtained in high yields and were characterized by high crystalline order (See FIGS. 5 and 6). The very similar inter-layer distances of WS₂ and MoS₂ makes them almost indistinguishable. Chemical analysis via EDS and EELS shows clear evidence for the existence of both molybdenum and tungsten, in addition to sulfur.

MoS₂ has shown a satisfactory covering ability atop template WS₂ nanotubes, applying CVT leading to WS₂@MoS₂ core/shell nanotubes with high quality, showing conformal and crystalline coating of the MoS₂ nanotubes over the WS₂ nanotubes.

The MoS₂ layers grew so as to continue the WS₂ ones in a quasi-epitaxial manner (See FIGS. 5A, 6). The two compounds, WS₂ and MoS₂ have very similar inter-layer distance, and therefore it is difficult to distinguish between them by means of imaging, but chemical analysis via EELS and EDS showed clear evidence of molybdenum existence, as can be seen in FIGS. 5B and 5C, respectively.

FIG. 5A presents a WS₂ nanotube with telescopic stacking of its outer layers. These top layers are believed to be composed of MoS₂ engulfing the WS₂ nanotube template. Also to be noticed is the defective structure of the outer layers in FIG. 6. This structural behavior can be associated with some unknown process occurring during the MoS₂ growth, or the core-shell structure cooling. It may be related to the (minor) differences in the thermal expansion coefficients of the two compounds. The slight difference in contrast between the inner and outer layers may also suggest the substance alternation, i.e. lower electron scattering by the lighter top molybdenum atoms as compared to the inner heavier tungsten atoms.

The chemical reaction proposed for the synthesis of molybdenum sulfide nanoparticles from molybdenum penta-chloride is:

2MoCl₅+14S→2MoS₂+5Cl₂S₂ (I)

A schematic illustration of this chemical reaction taking place on the surface of the INT-WS₂ template, resulting in core-shell INT, is given in scheme 3.

Alternatively, if sufficient humidity exists within the reactor, the reactive process might include:

MoCl₅+2H₂O→MoO₂+4HCl+0.5Cl₂ (II)

MoO₂+2S+4HCl→MoS₂+2H₂O+2Cl₂. (III)

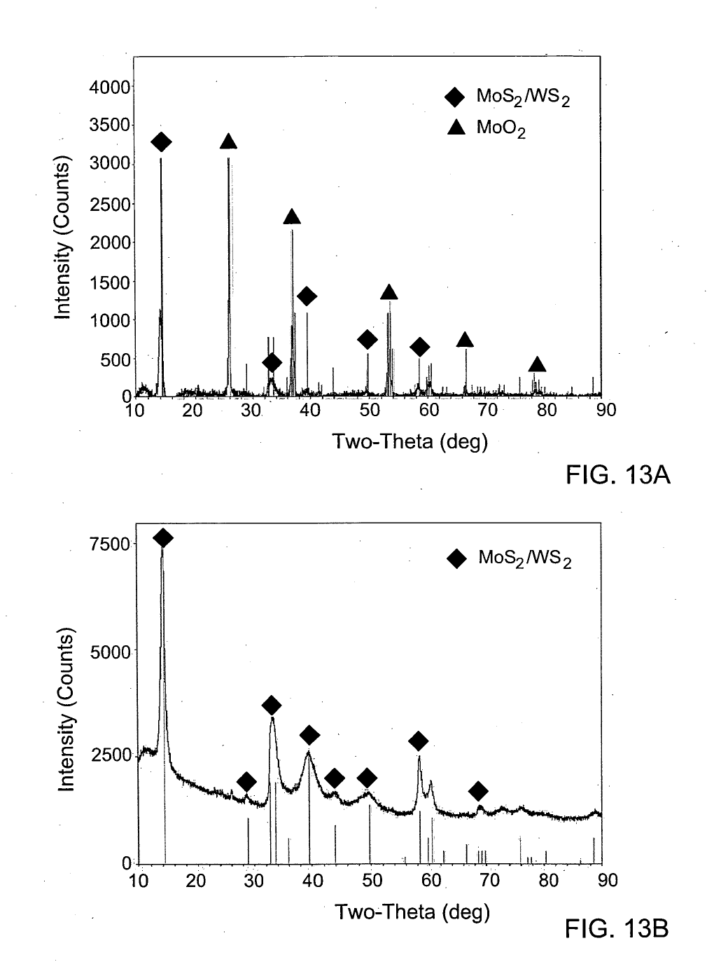

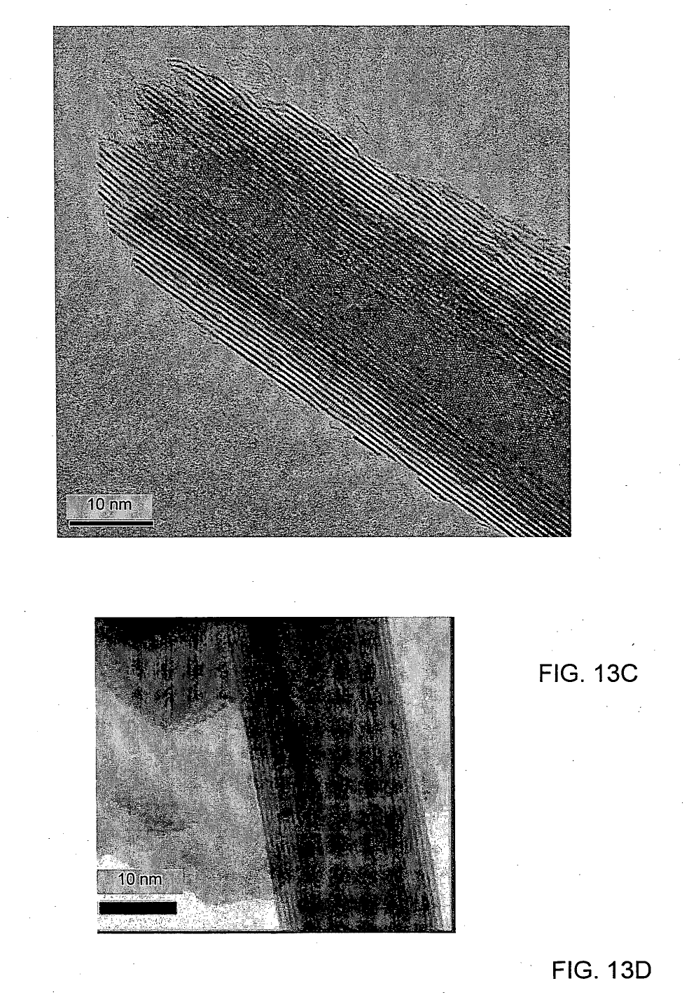

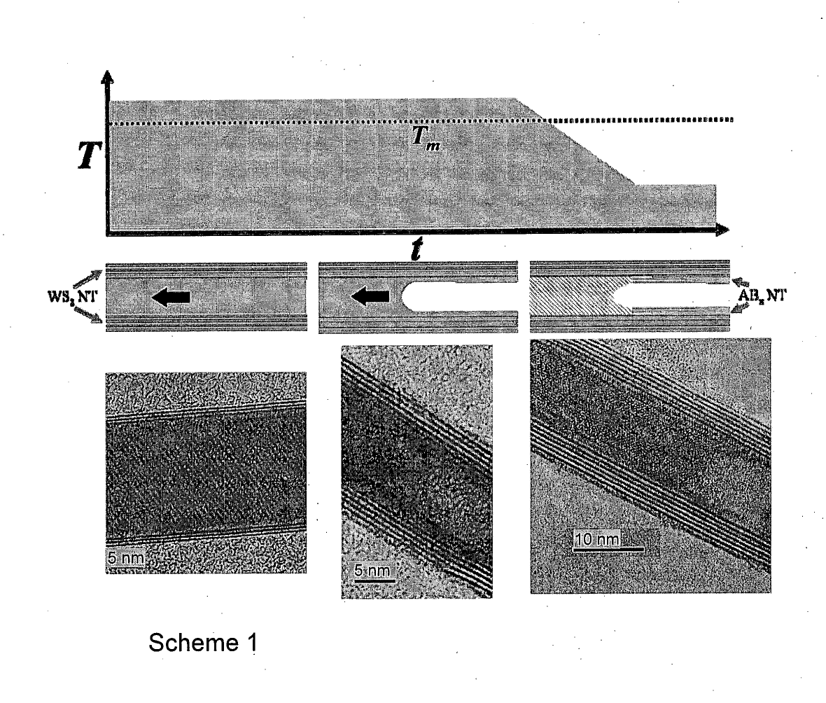

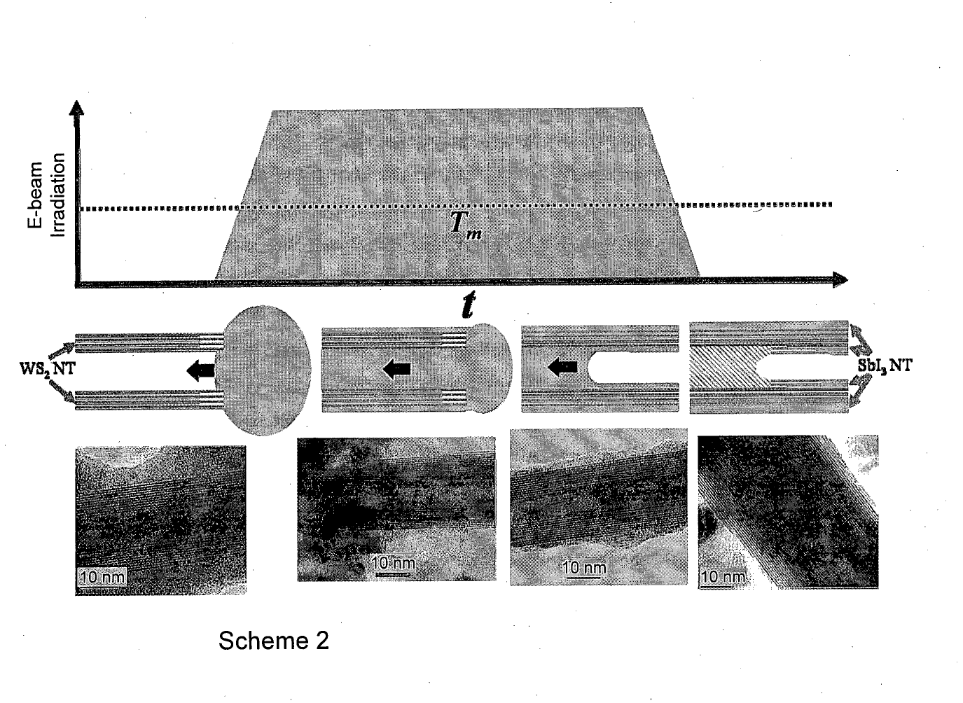

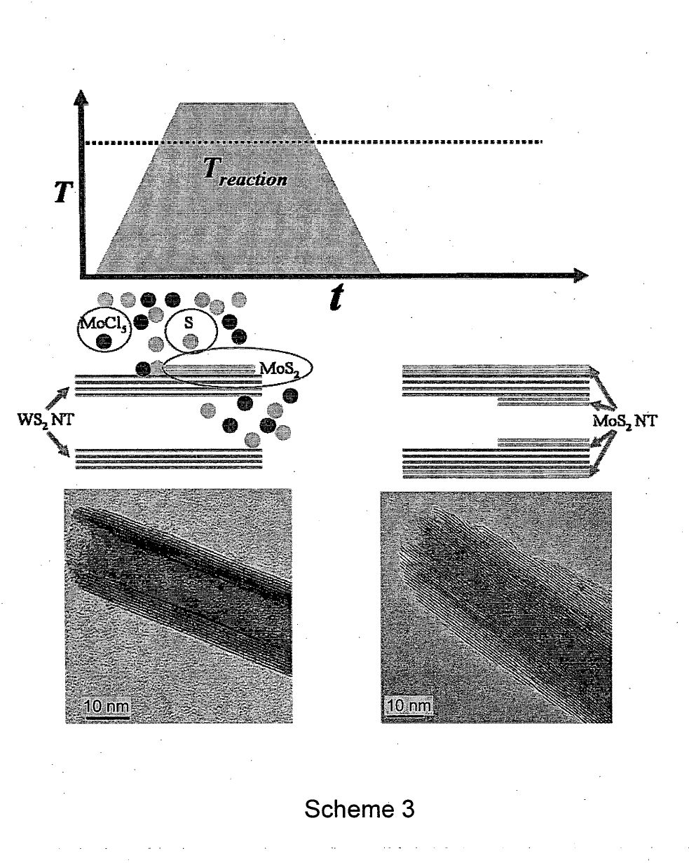

To further verify this latter proposed mechanism, an alternative two-step experiment has been conducted. In this procedure, the molybdenum chloride was heated in the presence of the template INT-WS₂ only (first step), and the second step is the reaction of the product with sulfur. After the first step, molybdenum dioxide peaks are found in the X-ray diffraction spectrum (FIG. 13A). This is an evidence for the existence of residual humidity inside the ampoule, in spite of the high vacuum pumping. Due to the hygroscopic nature of MoCl₅, water traces that are likely to remain in the ampoule even after pumping (especially those released upon heating from the wall), might be sufficient for the formation of the very stable phase of MoO₂. After further reaction with sulfur, the oxide peaks vanish and sulfide peaks are observed (FIG. 13B), indicating the process occurring in reaction (III). FIG. 13C shows TEM images taken from the final and intermediate products. The final product includes WS₂@MoS₂ core-shell nanotubes, as verified by chemical analysis techniques, in agreement with the direct synthesis route described earlier (see in FIGS. 5 and 6). Additionally to covering the outer surface of the INT-WS₂, a few MoS₂ layers are shown to form within its cavity, as seen in FIG. 13C. This experiment demonstrates that the route depicted by reactions (II) and (III), or analogous ones could also lead to superstructures of the kind MoS₂@WS₂@MoS₂ core-shell INT. A proposed mechanism for the formation of WS₂-MoS₂ core-shell INT is depicted in scheme 3, along with a micrograph of a MoS₂@WS₂@MoS₂ core-shell INT. It is noticeable that both reaction strategies utilize non-toxic sulfur powder for the sulfide synthesis rather than the toxic H₂S gas.

These simple, equilibrium gas-phase chemical reactions, when taking place in the vicinity of stable and nearly defect-free INT-WS₂, lead to a complex core-shell INT structures in very high yield. Furthermore, these core-shell nanostructures are also found to be almost defect free, affording them high stability and also other very favorable mechanical and other physical properties. These observations further illustrate the feasibility of INT to serve as templates for different sorts of reactions under different conditions. Furthermore, it is noticed that most of the new layers formed by the gas phase reaction appear on the outer surface of the template nanotube. There are a number of factors which can lead to this phenomenon. The reaction kinetics in the vapor phase is likely to be very rapid. The outer surface is exposed to larger concentrations of the precursors, and hence it is engulfed with closed MoS₂ layers more readily than the inner core of the nanotube. Furthermore, the strain energy of the closed MoS₂ shells is smaller on the outer surface as compared to the inner one.

### EXAMPLE 3

### Core-Shell INT by Wetting and Capillary Filling

30 mg of WS₂ nanoparticulate powder containing 5% multi-walled nanotubes (The nanotubes were typically 5-8 layers thick with inner and outer diameters of ca. 10 and 25 nm, respectively, and are a few microns long) was carefully mixed with 120 mg of iodide powder (PbI₂-98.5% Alfa Aesar, or BiI₃-99% Sigma Aldrich). The mixtures were gently ground using a mortar and pestle and then added with a proximal amount of 15 mg iodine (99.5% Alfa Aesar) before being transferred to a silica quartz ampoule. The ampoules were pumped under high vacuum (˜5×10⁻⁵ mbar) and sealed. The ampoules were dwelled for 14-30 days in a horizontal furnace at a constant temperature (500° C.) and then quenched to 0° C. in an icy water container.

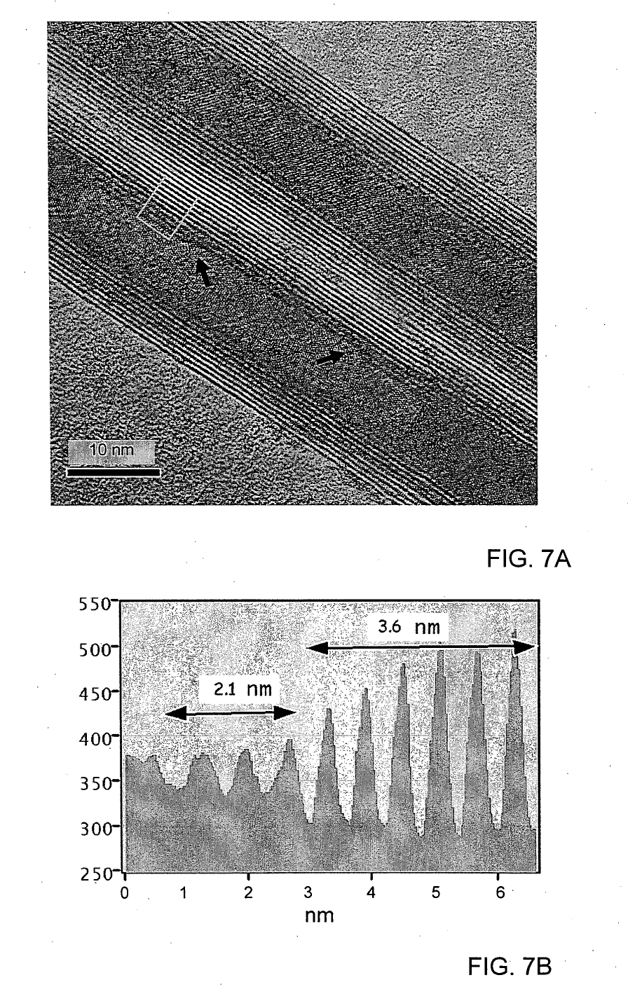

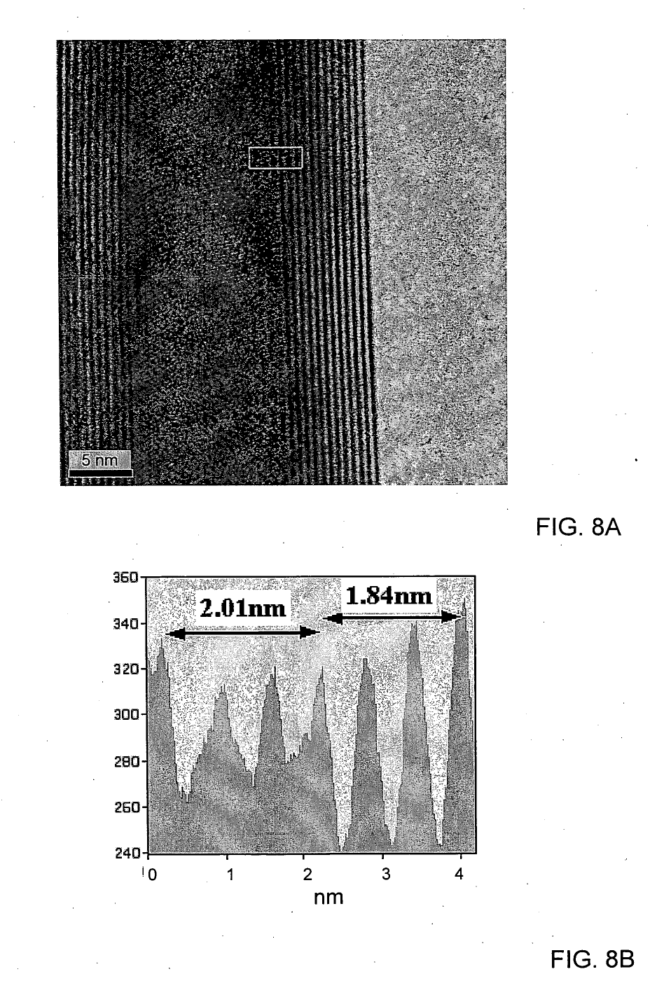

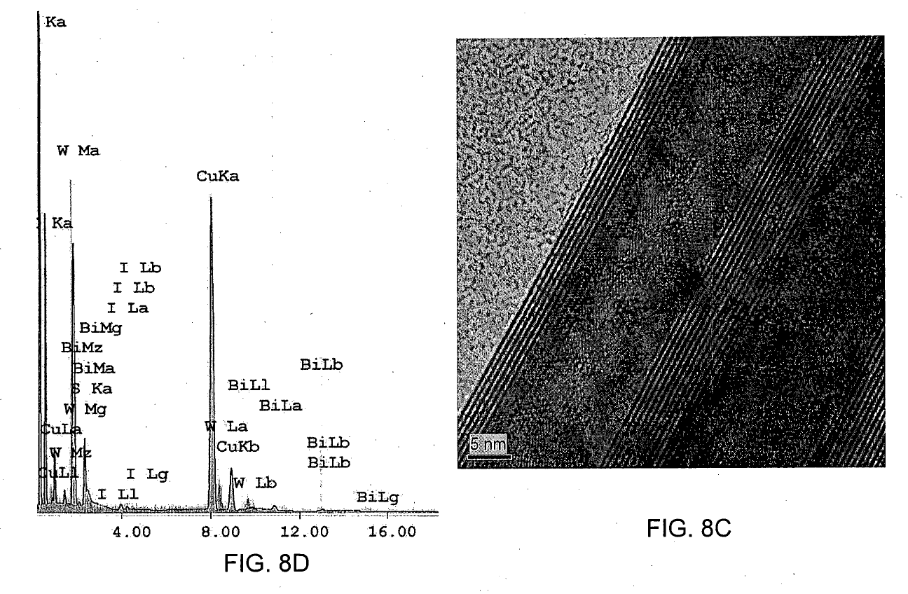

FIG. 7A shows a WS₂ nanotube which consists of a multilayered INT-WS₂ filled with crystalline PbI₂, and a segment of a PbI₂@WS₂ core-shell INT. This tube is adjacent to a second WS₂ nanotube hosting a single crystalline PbI₂ nanorod. An analogues WS₂-BiI₃ system is shown in FIG. 8A. FIGS. 7B and 8B are line profiles that demonstrate the layer spacing of the metal halides (around 7 Å for PbI₃ and BiI₃) and WS₂ (around 6.2 Å). This variation of crystalline parameters (see also Table 1) combined with chemical analysis techniques (EDS and EELS) confirm the core-shell superstructure of the INT. The above findings suggest that these core-shell nanotubular structures were obtained by wetting of the inner wall of the WS₂ nanotubes with a molten salt of the layered compounds PbI₂ and BiI₃ in thermodynamic equilibrium. Without being bound by theory it is stipulated that the molten salt (PbI₂) has a comparably strong van der Waals interaction with the transition metal dichalcogenide INT inner walls, allowing good wettability. This characteristics allows a total spread of the liquid, which remains behind the progressing leading front of the drop on the inner surface of the host INT. This coated melt may crystallize to form inner tubular layers during the cooling, thus forming a core-shell INT. In agreement with the molecular dynamics calculations, the core-shell INT are terminated by a concave meniscus, indicating the strong interfacial forces between the molten salt and the inner walls of the tube. Upon cooling, the molten salt may solidify in the form of crystalline nanorods; a polycrystalline segment or even solidified amorphous matter in the inner core of the templating INT. Scheme 1 illustrates the general possible mechanism, presenting snap-shots from the different stages of the process. Due to the quenching of the samples, some intermediate species may also occur and can be employed to obtain a better understanding of the core-shell INT formation mechanism.

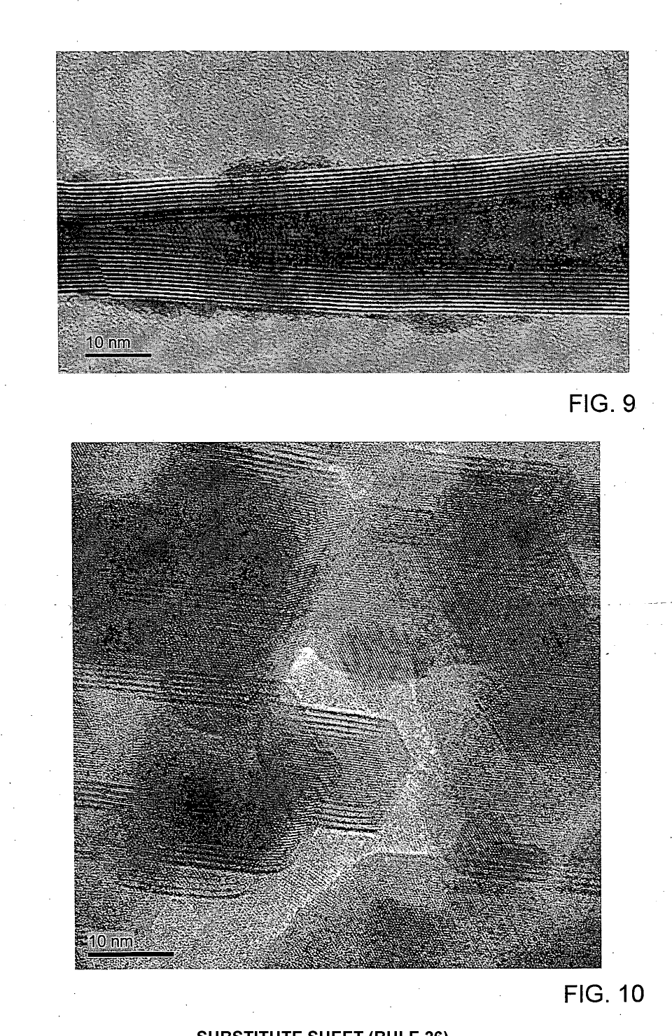

An interesting transition between a BiI₃ nanorod and nanotube trapped in an INT-WS₂ is presented in FIG. 9. Unlike the examples given above, in this figure the outer INT-WS₂ walls are not parallel, causing a variation of the inner-core diameter and hence the strain in the core BiI₃ layers, depending on the lateral position. In this core-shell INT, the enclosure of the inner salt layers into a core nanotube is energetically favorable only below some cutoff strain, namely, above some value of the shell nanotube inner diameter. It is assumed that below that diameter, the energy reduction due to the elimination of dangling bonds is exceeded by the additional strain energy. This energy balance causes an inner nanorod or nanowire to be more favorable, akin to the case of narrower nanotubes such as CNT and INT-BN.

### EXAMPLE 4

### Core-Shell INT Synthesis via Electron Beam Irradiation

A saturated solution of SbI₃ (anhydrous, 10 mesh, 99.999% Sigma Aldrich) in dehydrated ethanol (max 0.01% H₂O, SeccoSolv) was prepared, added with approximately 50 mg of WS₂ nanoparticualte powder and mixed (via 5 minutes sonication followed by 4 hours of magnetic plate stirring at 80° C.). The product was then placed on a carbon!Formvar© coated Cu grid and inserted in a CM-120 Philips TEM. When a WS₂ nanotube was found to be in the vicinity of the antimony iodide powder, the e-beam was settled upon it for a few minutes, until melting and filling or wetting of the nanotubes with the compound occurred.

Closed-cage structures have been obtained from PbI₂ by using a focused electron beam irradiation, as presented in FIG. 10. Without being bound by theory it is stipulated that the mechanism leading to the formation of these nested close-caged nanoparticles is evaporation of the compound followed by recrystallization. This mechanism is different, however, from the proposed mechanism for the formation of carbon onions (the ‘knock on’ mechanism), owing to the low melting and boiling temperatures of the halides, which allow evaporation by electron irradiation. Furthermore, the vapor pressure of the halides in the column is negligible and no compensation for the e-beam knocked-out carbon atoms is possible here.

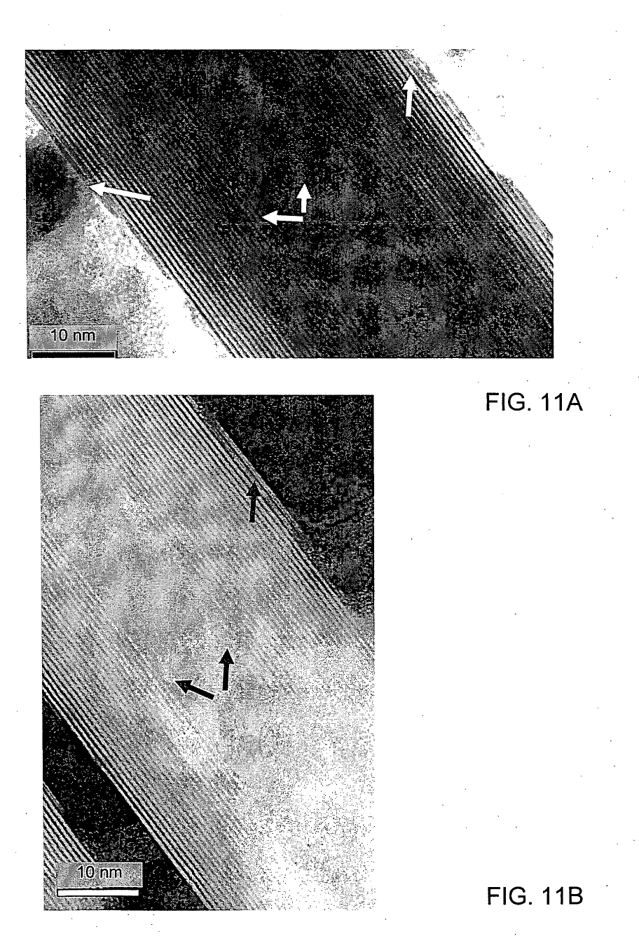

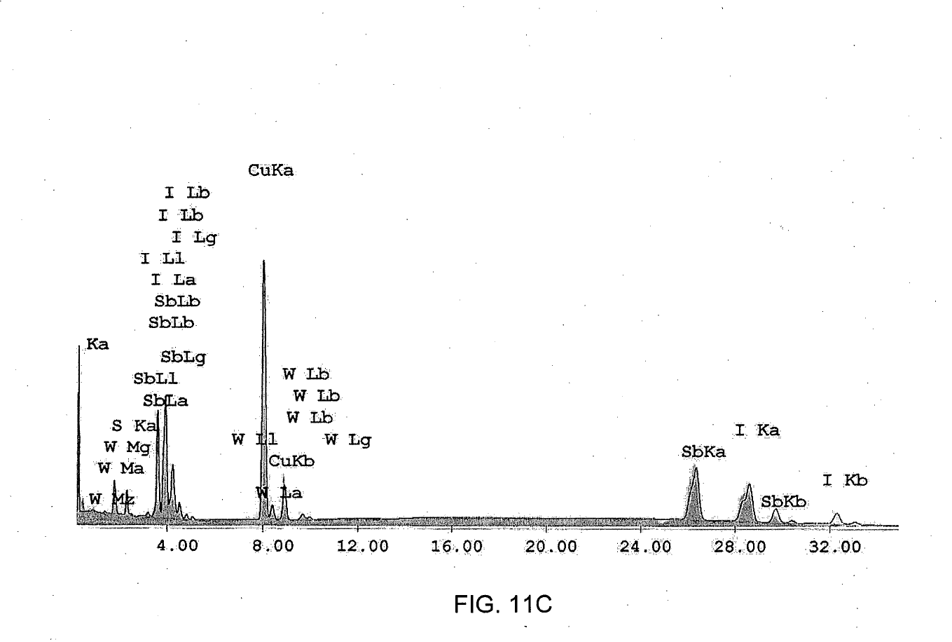

An analogous result is achieved while irradiating a powder of a layered compound with low melting (boiling) temperature in the presence of stable WS₂ nanotubes. A case in this point is the irradiation of a powder of SbI₃, with melting and boiling points of 168° C. and 401° C., respectively. In the TEM micrograph shown in FIG. 11A, details the layers of SbI₃ wrapped around the outer surface of an INT-WS₂, and also on its innermost layer. The micrograph shown in FIG. 11 B shows a typical SbI₃@WS₂ core-shell nanotube. In FIG. 11B the negative of FIG. 11A is shown in order to emphasize the SbI₃@WS₂ superstructure. The SbI₃ layers are marked with arrows.

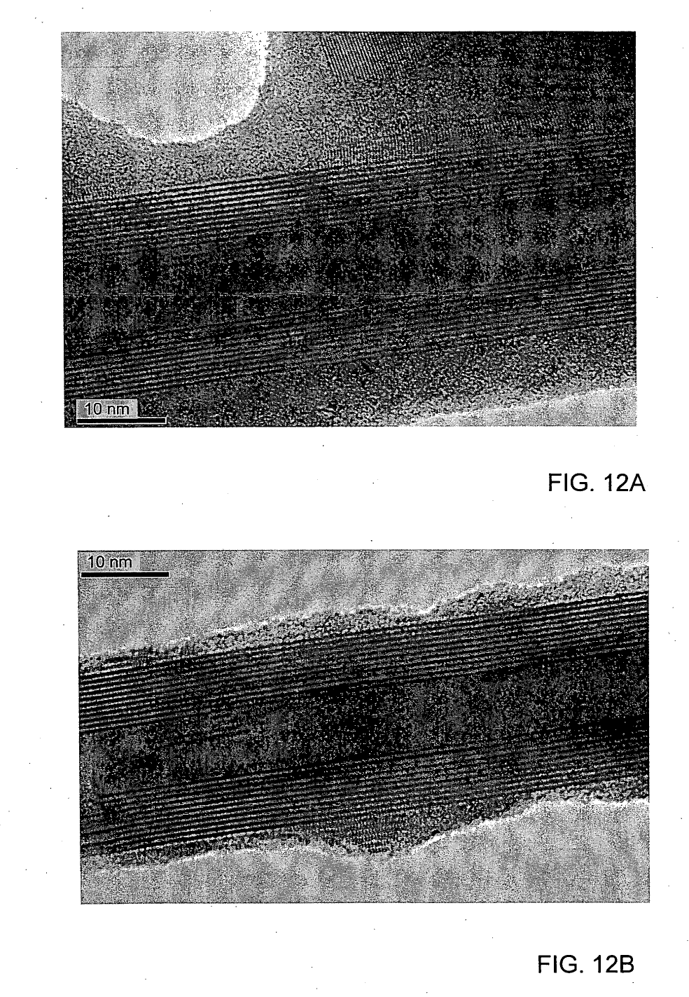

The focused electron beam of the TEM has sufficient energy density to evaporate the SbI₃ powder. Subsequently, the vapors condense on the surfaces of the nearby template WS₂ nanotube, which is a very comfortable nucleation site. In some places the crystalline layers are interfaced with an amorphous Sb-Iₓ phase (see FIG. 12B). It should be emphasized that the electron beam performs as a nanometric heating source for an ‘annealing’ process in the material. These experiments expose the irradiated materials to conditions that are extremely far from thermodynamic equilibrium.

However, the low melting point of SbI₃ may suggest some modification to the above mechanism; it is possible that during electron beam irradiation, the temperature of the INT-WS₂ surfaces, which are well above the melting point of SbI₃, allow it to melt, wet these surfaces and flow along them. This creates basically a wetting process, which may be followed by partial or complete crystallization, or solidification into an amorphous state. An example to this complex situation is presented in FIG. 12A. In this TEM micrograph, perfect wetting of the outer surface of an INT-WS₂ by molten SbI₃ salt is seen. While most of the SbI₃ is in amorphous state, parts of the salt have already been crystallized as isolated nanoparticles. It is possible, that from this situation, one can obtain a core-shell INT (see FIG. 11), via repetitive melting/migration and solidification cycles. In FIG. 12B, partial crystallization of the SbI₃ layers onto the INT-WS₂ outer surface is seen. In both FIGS. 12A and 12B, short segments of tubular SbI₃ layers are present within the INT-WS₂, possibly due to capillarity-diffusion and crystallization events. This solid-liquid-vapor process is yet to be fully understood. These difficulties arise from the poor control of the annealing conditions provided by the electron irradiation. The addition of an external heating source may open new reaction channels not explored hitherto by the present process. A simplified mechanism proposed for the formation of the core-shell INT discussed above is illustrated in scheme 2.

### Transmission Electron Microscopy

All products described above were sonicated in dehydrated ethanol (max 0.01% H₂O, SeccoSolv), placed on a carbon/Formvar© coated Cu grid, and analyzed by transmission electron microscopy; the microscopes in use were the Philips CM-120, 120 kV, equipped with an EDS detector (EDAX), and for high resolution the FEI Tecnai F-30 equipped with a parallel electron energy loss spectroscopy (EELS) detector (Gatan imaging filter-GIF (Gatan)) for chemical analysis.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. Section headings used herein should not be construed as necessarily limiting.

It is expected that during the life of a patent maturing from this application many relevant layered compounds and/or inorganic nanotubes will be developed and the scope of the terms layered compound and inorganic nanotube is intended to include all such new technologies a priori

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

The terms “comprises”, “comprising”, “includes”, “including”, “having” and their conjugates mean “including but not limited to”. The term “consisting of means “including and limited to”. The term “consisting essentially of means that the composition, method or structure may include additional ingredients, steps and/or parts, but only if the additional ingredients, steps and/or parts do not materially alter the basic and novel characteristics of the claimed composition, method or structure.

Whenever a structure, method, or the like is described to comprise certain actions or components, this is intended to disclose structures or methods that comprise said actions or component, structures or methods that consist essentially of said actions or components and methods or structures that consists of said actions or components.

As used herein, the singular form “a”, “an” and “the” include plural references unless the context clearly dictates otherwise. For example, the term “a compound” or “at least one compound/material” may include a plurality of compounds or materials, including mixtures thereof.

Throughout this application, various embodiments of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 2 to 4, from 3 to 6 etc., as well as individual numbers within that range, for example, 1, 2, 2.25, etc.

1-33. (canceled)

34. A multilayered nanostructure, comprising:
at least one first layered nanotube comprising at least one first inorganic material and having an inner void holding at least one second layered nanotube comprising at least one second inorganic material;
wherein the at least one first nanotube and at least one second nanotube differ in at least one of structure and material.

35. The multilayered nanostructure according to claim 34, wherein the at least one first inorganic material is of general formula (I):
MₚXₙY_{q} (I)
wherein
M is a metal selected from an alkali metal, alkaline earth metal, transition metal, post-transition metal, metalloid, lanthanoid metal, and actinoid metal;
X and Y are independently selected from N, O, P, S, halide, Se, and Te; and
n, p and q are integers each independently selected from 0, 1, 2, 3, 4, and 5.

36. The multilayered nanostructure according to claim 34, wherein the at least one second inorganic material is of general formula (II):
M′ₚX′ₙY′_{q} (II)
wherein
M′ is a metal selected from an alkali metal, alkaline earth metal, transition metal, post-transition metal, metalloid, lanthanoid metal, and actinoid metal;
X′ and Y′ are independently selected from N, O, P, S, halide, Se, and Te; and
n, p and q are integers each independently selected from 0, 1, 2, 3, 4, and 5.

37. The multilayered nanostructure according to claim 34, wherein the at least one first and at least one second inorganic material are each independently selected from the group consisting of WS₂, MoS₂, PbI₂, Bil₃, Sbl₃, Cdl₂, NbS₂, MoCl₂, BN, V₂O₅, ReS₂, CdCl₂, Cdl₂, NiBr₂, Ti₂O, Tl₂O, Cs₂O, PtO₂, NiPS₃, FePS₃, and any combination thereof.

38. The multilayered nanostructure according to claim 34, wherein the at least one first nanotube being of at least two inorganic materials.

39. The multilayered nanostructure according to claim 34, wherein the at least one second nanotube comprising at least two inorganic materials.

40. The multilayered nanostructure according to claim 34, having a core shell structure wherein the at least one first nanotube constitutes the shell and the at least one second nanotube constitutes the core.

41. The multilayered nanostructure according to claim 34, wherein the at least one first nanotube has a melting point higher than the melting point of the at least one second nanotube.

42. The multilayered nanostructure according to claim 34, wherein the at least one second nanotube has a melting point higher than the melting point of the at least one first nanotube.

43. The multilayered nanostructure according to claim 34, wherein the inner void of the at least one first nanotube has an internal diameter of at least 6 nm.

44. The multilayered nanostructure according to claim 34, wherein the inner void of the at least one first nanotube has an internal diameter of between about 6 to about 10 nm.

45. The multilayered nanostructure according to claim 34, wherein the at least one first nanotube and at least one second nanotube have substantially similar ionicity values (%).

46. A solid lubricant comprising at least one multilayered nanostructure according to claim 34.

47. A radiation detector comprising at least one multilayered nanostructure according to claim 34.

48. A method of producing a multilayered nanostructure according to claim 34, selected from one of the following:
a method comprising:
(a) providing a template nanostructure comprising at least one first layered nanotube comprising at least one first inorganic material, having an inner void;
(b) mixing the template with at least one second inorganic material or a precursor thereof; and
(c) applying conditions on the mixture to enable construction of at least one second nanotube of at least one second inorganic material within the inner void of the template, thereby forming the multilayered nanostructure;
or, a method comprising:
(a) providing at least one first inorganic material or a precursor thereof;
(b) mixing the at least one first inorganic material with a template nanostructure comprising at least one second nanotube being of at least one second inorganic material; and
(c) applying conditions on the mixture to enable construction of at least one first nanotube of at least one first inorganic material on the outer surface of the template, thereby forming the multilayered nanostructure;
or, a method comprising:
(a) providing at least one first nanotube comprising at least one first inorganic material;
(b) mixing the at least one first nanotube with at least one second inorganic material having a melting point lower than the melting point of the at least one first nanotube;
(c) applying at least one of (i) heat to the mixture above the melting point of the at least one second inorganic material or (ii) focused electron beam irradiation to the mixture, thereby providing a heated mixture; and
(d) cooling the heated mixture to obtain the multilayered nanostructure;
or, a method comprising:
(a) providing at least one first nanotube comprising at least one first inorganic material;
(b) mixing the at least one first nanotube with at least one inorganic precursor of at least one second inorganic material to obtain an initial reaction mixture;
(c) adding at least one chalcogen to the initial reaction mixture to obtain a final reaction mixture;
(d) applying heat to the final reaction mixture capable of gasifying the at least one inorganic precursor and at least one chalcogen, thereby providing a heated mixture; and
(e) cooling the heated mixture to obtain the multilayered nanostructure.

49. The method according to claim 48, wherein the at least one first inorganic material is selected from the group consisting of WS₂, MoS₂, Pbl₂, Bil₃, Sbl₃, Cdl₂, NbS₂, MoCl₂, BN, V₂O₅, ReS₂, CdCl₂, Cdl₂, NiBr₂, Ti₂O, Tl₂O, Cs₂O, PtO₂, NiPS₃, FePS₃, and any combination thereof.

50. A mulilayered nanostructure selected from the group consisting of
Pbl₂@WS₂,
Bil₃@WS₂,
Sbl₃@WS₂,
WS₂@MoS₂,
Pbl₂@WS₂@Pbl₂, and
Sbl₃@WS₂@Sbl₃.
